(19) United States
(12) Patent Application Publication
(10) Pub. No.: US 2018/0232464 A1
(43) Pub. Date: Aug. 16, 2018

(54) AUTOMATIC TRANSFORMATION OF A MULTITUDE OF DISPARATE TYPES OF INPUT DATA INTO A HOLISTIC, SELF-CONTAINED, REFERENCE DATABASE FORMAT THAT CAN BE RENDERED AT VARYING LEVELS OF GRANULARITY

(71) Applicant: Mastery Transcript Consortium, Gates Mills, OH (US)

(72) Inventors: Donald Scott Looney, Gates Mills, OH (US); Jonathan Allen Bower, Wayland, MA (US); David C. Batchelder, Kittery Point, ME (US); Benjamin Ian Rein, Solon, OH (US); Emily Nesbitt McCarren, Honolulu, HI (US); Doris Elizabeth Korda, Cleveland Heights, OH (US); Michael Andrew Nachbar, Seattle, WA (US); Christopher B. Maxey, Lawrenceville, NY (US); Julia Russell Eells, San Francisco, CA (US); Patricia C. Russell, Brookline, MA (US)

(21) Appl. No.: 15/896,794

(22) Filed: Feb. 14, 2018

Related U.S. Application Data
(60) Provisional application No. 62/459,568, filed on Feb. 15, 2017.
(60) Provisional application No. 62/465,070, filed on Feb. 28, 2017.

(51) Int. Cl. G06F 17/30; G06T 19/00

(52) U.S. Cl. CPC G06F 17/30997; G06F 17/30604; G06F 17/30005; G06F 3/011; G06F 17/30522; G06F 17/30867; G06T 19/003; G06F 17/30312

(57) ABSTRACT

Techniques facilitating automatic transformation of a multitude of disparate types of input data into a holistic, self-contained, reference database format that can be rendered at varying levels of granularity are provided. A system can comprise a memory that stores computer executable components and a processor that executes the computer executable components stored in the memory. The computer executable components can comprise a data manager component that receives first data and second data from a source entity and an analysis component that adds a first metadata to the first data based on a first set of content, and adds a second metadata to the second data based on a second set of content. Further, the computer executable components can comprise an output component that renders aggregated content at varying viewing granularity levels based on a request for a holistic life view of the target entity.

### CROSS-REFERENCE TO RELATED APPLICATIONS

This application claims the benefit of U.S. Provisional Patent Application Ser. No. 62/459,568, filed Feb. 15, 2017, and entitled “AGGREGATION-BASED QUALITATIVE ASSESSMENT” and U.S. Provisional Patent Application Ser. No. 62/465,070, filed Feb. 28, 2017, and entitled “HOLISTIC DATA CAPTURE AND ANALYSIS.” The entireties of these applications are expressly incorporated herein by reference.

### BACKGROUND

Computing devices and communication networks are employed daily to capture life experiences, communicate with others, and/or to perform daily tasks. The data input into the computing devices can be in different formats and/or can be received into different software programs, which can be incompatible with each other. Further, due to limited capabilities of the computing devices (e.g., storage space, processing limitations, and so on), the data input into the computing devices is generally not retained for long periods of time and, therefore, can be deleted to conserve resources of the computing devices. In some instances, the data can be saved to an internet-based network, which can have limitations as to how the data is output. Accordingly, the use of the data retrieved from the computing device and/or internet-based network is dependent on the underlying software program and does not provide meaningful categorization and presentation of the data.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, systems, computer-implemented methods, apparatuses, and/or computer program products that facilitate automatic transformation of a multitude of disparate types of input data into a holistic, self-contained, reference database format that can be rendered at varying levels of granularity are provided.

According to an embodiment, provided herein is a system that can comprise a memory that stores computer executable components and a processor that executes the computer executable components stored in the memory. The computer executable components can comprise a data manager component that receives first data and second data from a source entity. The computer executable components can also comprise an analysis component that adds a first metadata to the first data based on a first set of content, and adds a second metadata to the second data based on a second set of content. Further, the computer executable components can comprise an output component that renders aggregated content at varying viewing granularity levels based on a first request for the holistic life view of the target entity.

Another embodiment provide herein is a method that can comprise receiving, by a system operatively coupled to a processor, a first set of content related to a first target entity and a second set of content related to a second target entity. The method can also comprise augmenting, by the system, the first set of content with a first metadata and the second set of content with a second metadata. Further, the method can comprise storing, by the system, the first set of content, the first metadata, the second set of content, and the second metadata in a reference database that comprises a first set of historical content associated with the first target entity and a second set of historical content associated with the second target entity. In addition, the method can comprise outputting, by the system, at varying viewing granularity levels, at least one of a first set of aggregated content and a second set of aggregated content.

A further embodiment can relate to a computer readable storage device comprising executable instructions that, in response to execution, cause a system comprising a processor to perform operations. The operations can comprise receiving first data and second data from a source entity. The first data can comprise a first set of content and the second data can comprise a second set of content. The first set of content and the second set of content can contribute to a holistic life view of a target entity. The operations can also comprise adding a first metadata to the first data based on the first set of content and a second metadata to the second data based on the second set of content. Further, the operations can comprise outputting aggregated content at varying viewing granularity levels based on a first request for the holistic life view of the target entity. The aggregated content can comprise the first set of content, the second set of content, and historical information determined to be associated with the target entity.

To the accomplishment of the foregoing and related ends, one or more aspects comprise features hereinafter fully described and particularly pointed out in the claims. The following description and annexed drawings set forth in detail certain illustrative features of one or more aspects. These features are indicative, however, of but a few of various ways in which principles of various aspects can be employed. Other advantages and novel features will become apparent from the following detailed description when considered in conjunction with the drawings and the disclosed aspects are intended to include all such aspects and their equivalents.

DESCRIPTION OF THE DRAWINGS

Various non-limiting embodiments are further described with reference to the accompanying drawings in which:

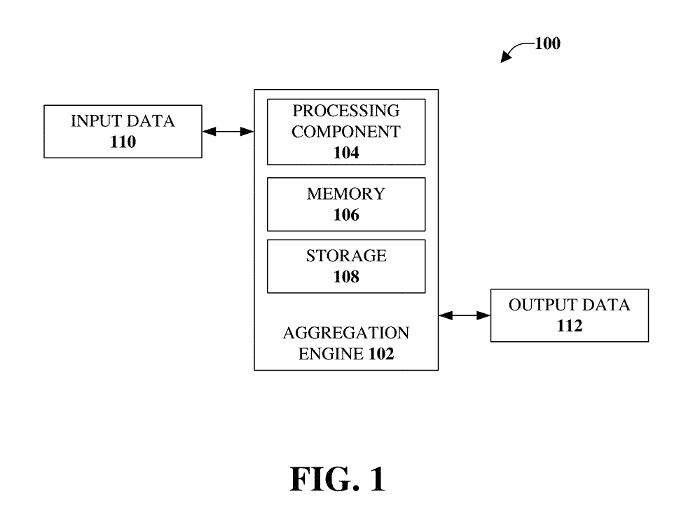

FIG. 1 illustrates a block diagram of an example, non-limiting, system that facilitates aggregation-based qualitative assessment in accordance with one or more embodiments described herein;

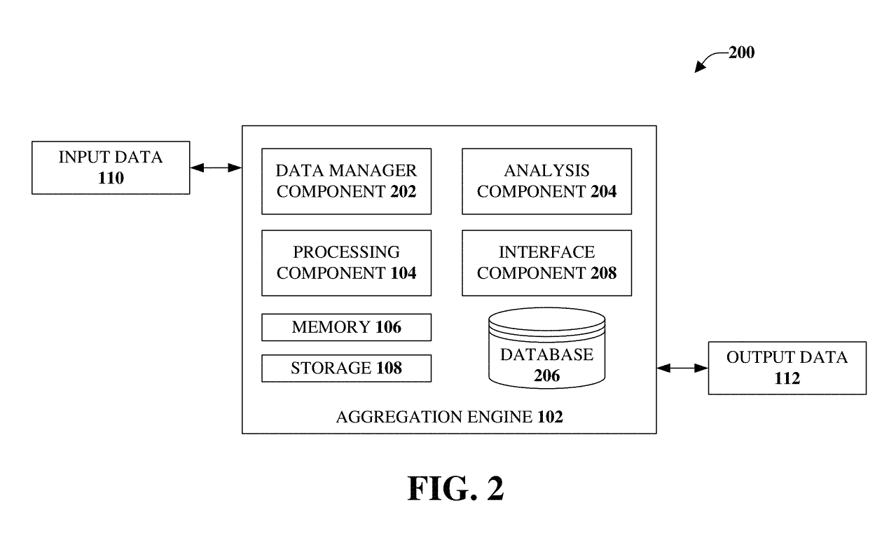

FIG. 2 illustrates a block diagram of an example, non-limiting, system for facilitating aggregation-based qualitative assessment in accordance with one or more embodiments described herein;

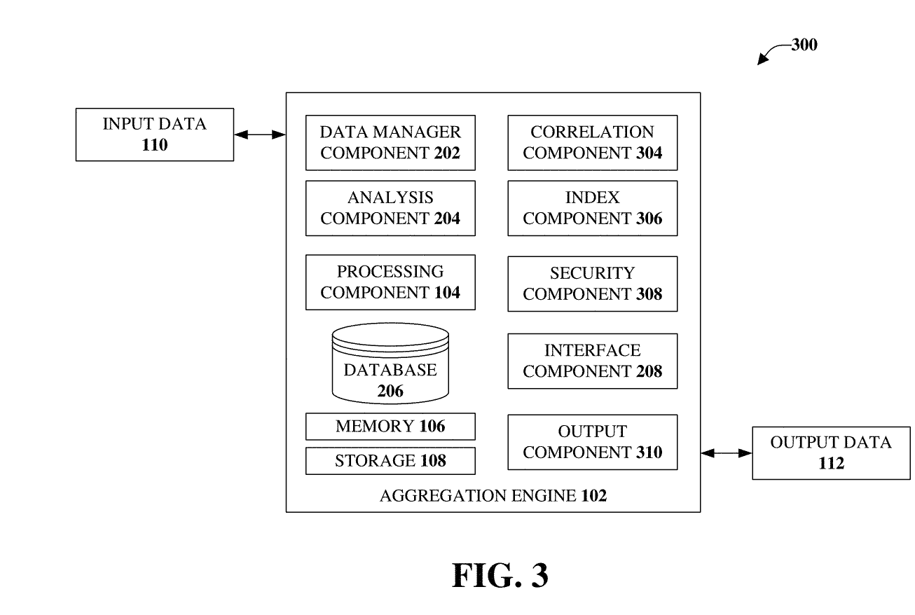

FIG. 3 illustrates a block diagram of an example, non-limiting, system for facilitating categorization of accumulated data in accordance with one or more embodiments described herein;

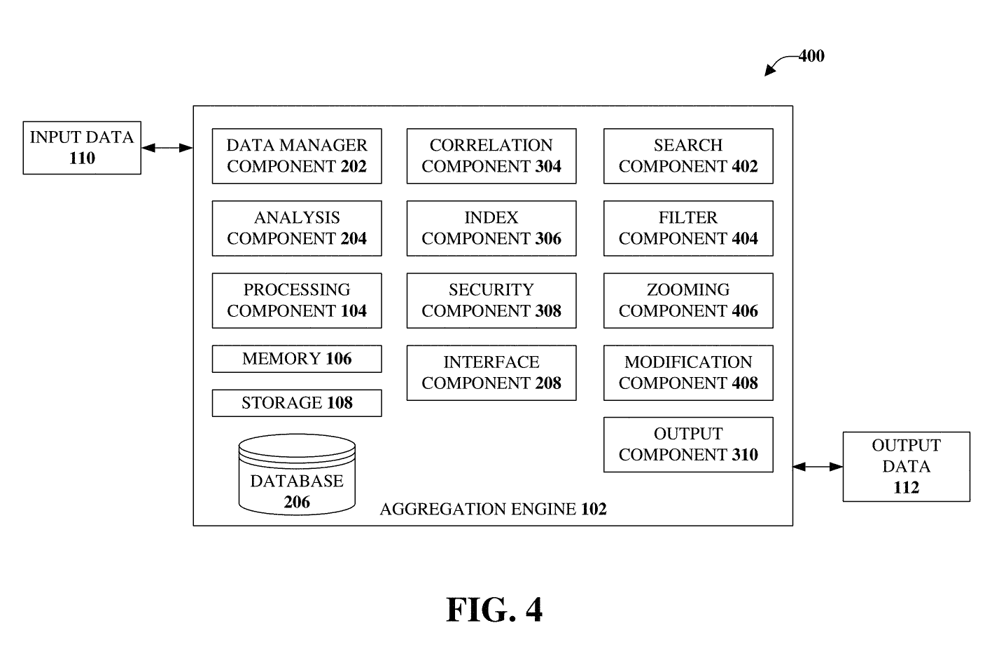

FIG. 4 illustrates a block diagram of an example, non-limiting, system for facilitating aggregation-based qualitative assessment in accordance with one or more embodiments described herein;

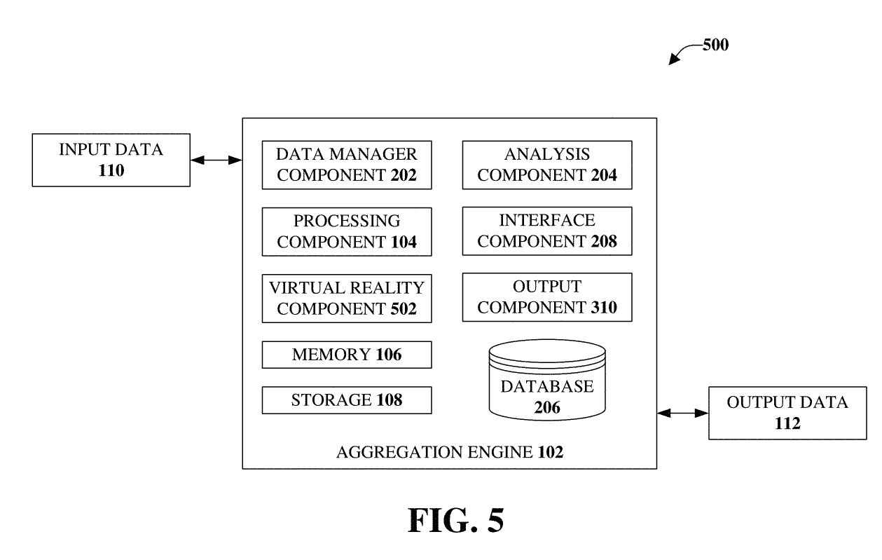

FIG. 5 illustrates an example, non-limiting, system that provides a virtual reality view of data in accordance with one or more embodiments described herein;

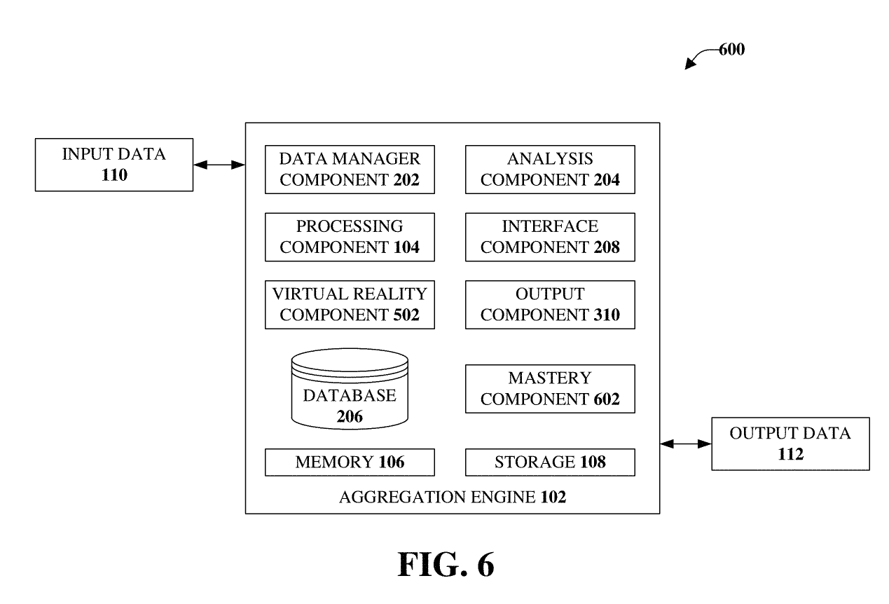

FIG. 6 illustrates an example, non-limiting, system that incorporates input entity assessment in accordance with one or more embodiments described herein;

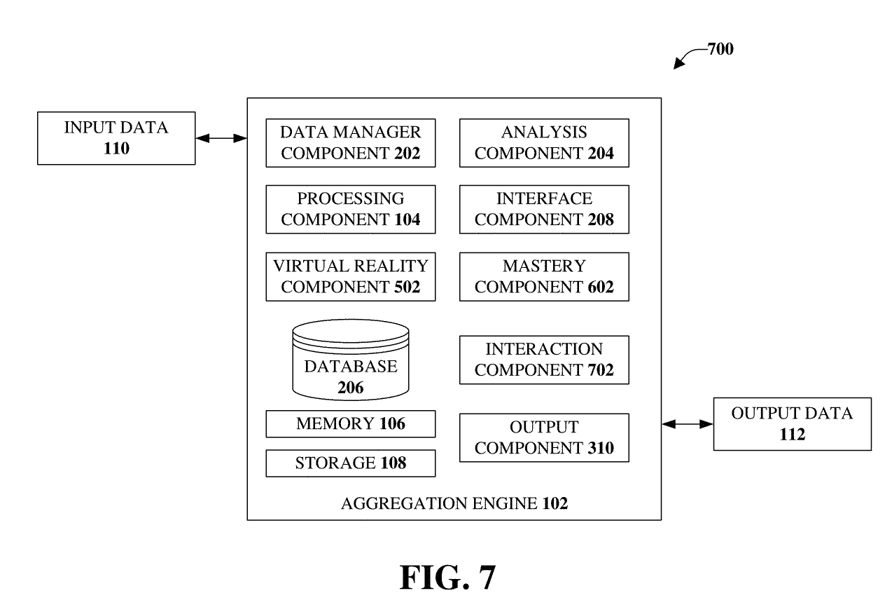

FIG. 7 illustrates an example, non-limiting, system that facilitates interaction between a requesting entity and data contained in a holistic view in accordance with one or more embodiments described herein;

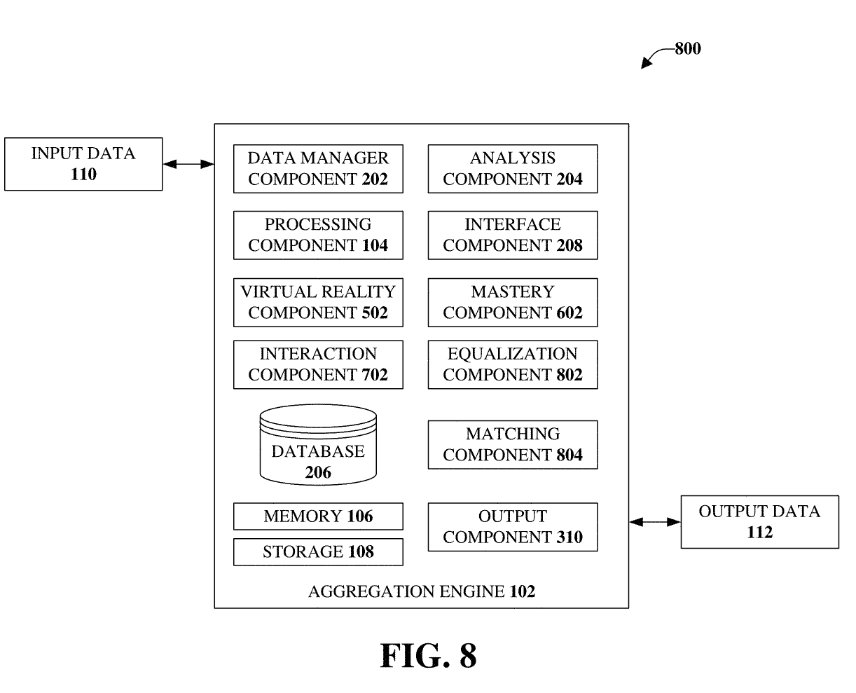

FIG. 8 illustrates an example, non-limiting, system for standardizing content across a variety of input sources in accordance with one or more embodiments described herein;

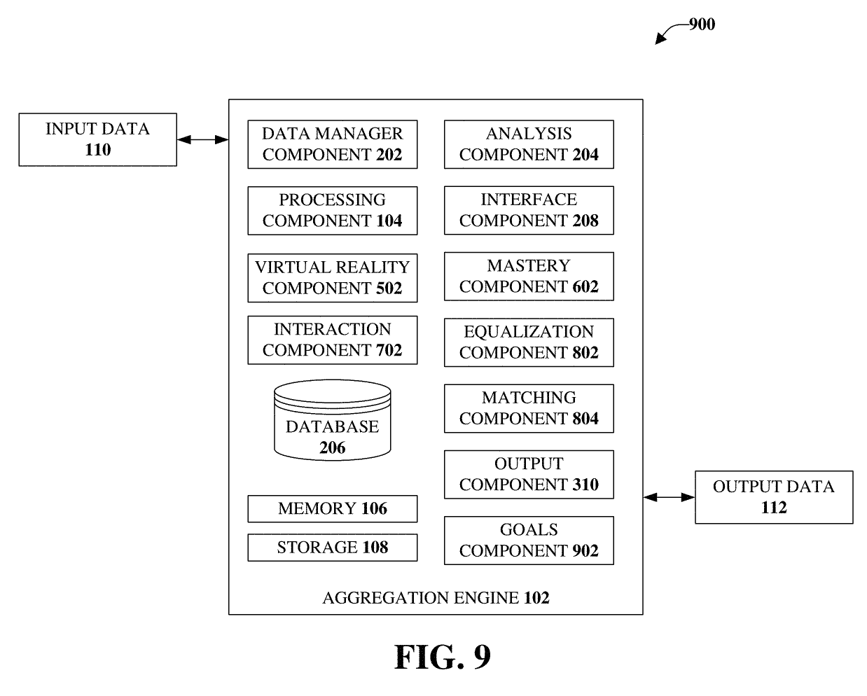

FIG. 9 illustrates an example, non-limiting, system for aligning goals of a target entity with experiences of the target entity in accordance with one or more embodiments described herein;

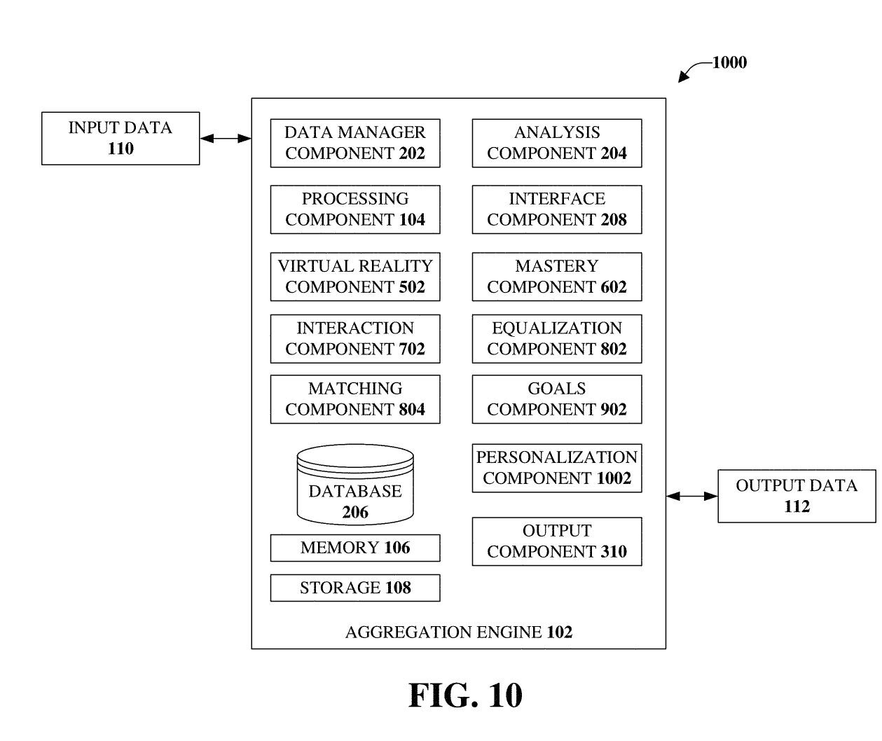

FIG. 10 illustrates an example, non-limiting, system that provides for personalization of data input in accordance with one or more embodiments described herein;

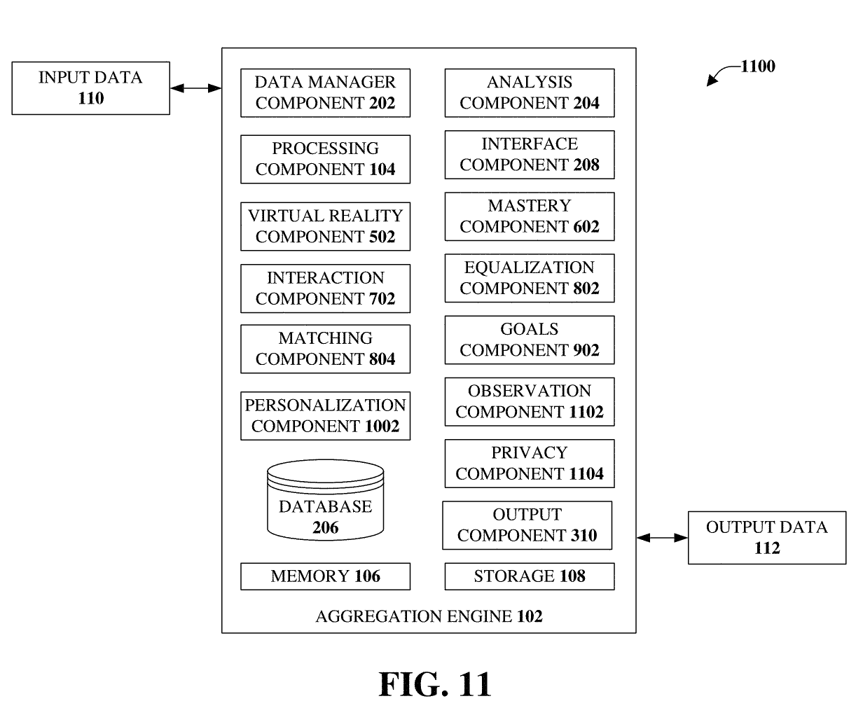

FIG. 11 illustrates an example, non-limiting, system that can provide policing and privacy of aggregation-based qualitative assessment data in accordance with one or more embodiments described herein;

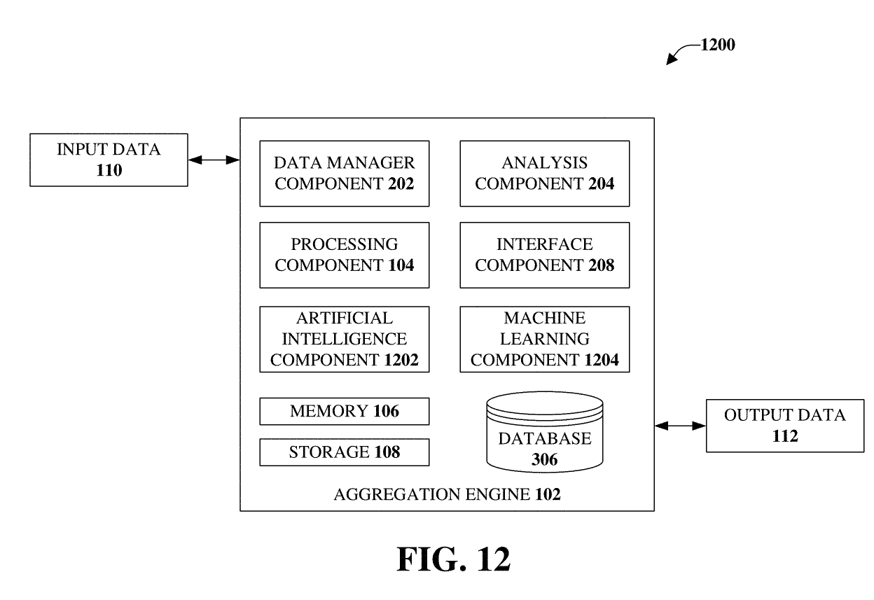

FIG. 12 illustrates an example, non-limiting system that automates various aspects of the one or more embodiments described herein;

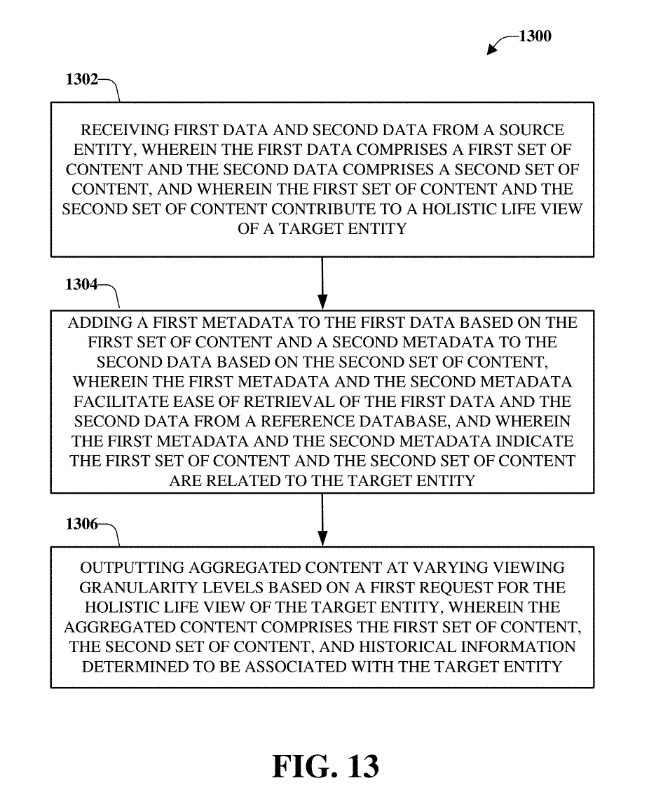

FIG. 13 illustrates a flow diagram of an example, non-limiting, computer-implemented method that facilitates automatic transformation of a multitude of disparate types of input data into a holistic, self-contained, reference database format that can be rendered at varying levels of granularity in accordance with one or more embodiments described herein;

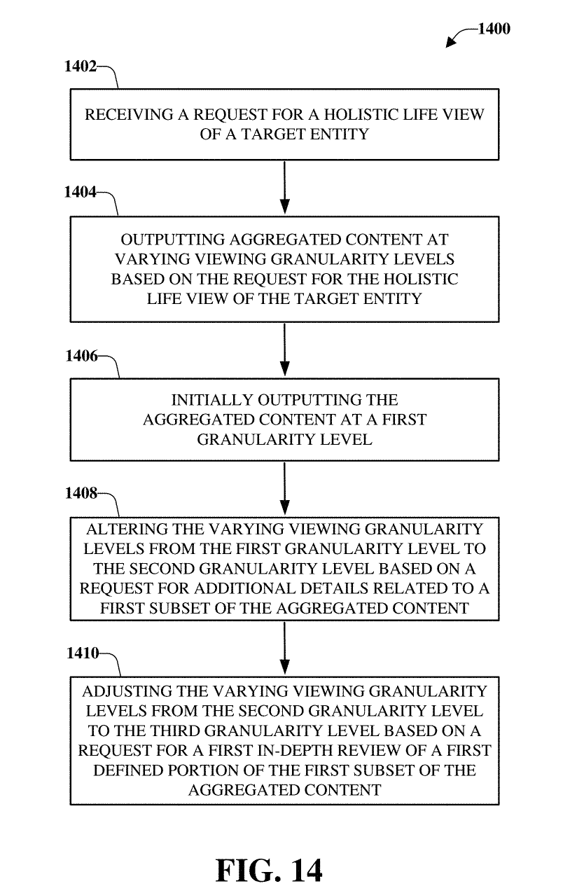

FIG. 14 illustrates a flow diagram of an example, non-limiting, computer-implemented method that facilitates rending a holistic life view of a target entity at varying levels of granularity in accordance with one or more embodiments described herein;

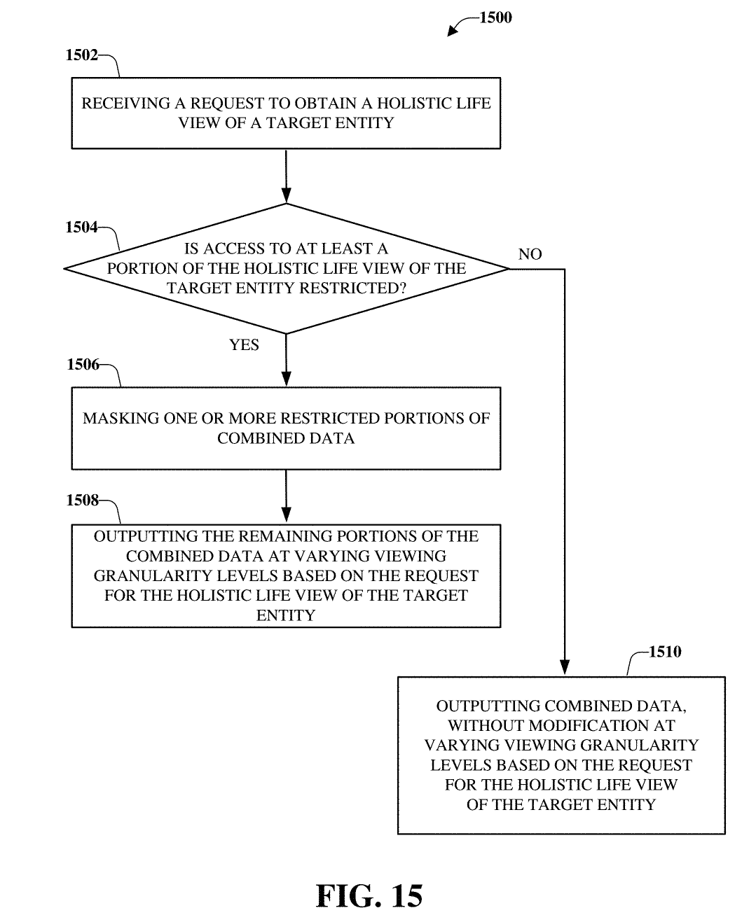

FIG. 15 illustrates a flow diagram of an example, non-limiting, computer-implemented method that facilitates rending a holistic life view of a target based on one or more defined rendering criteria in accordance with one or more embodiments described herein;

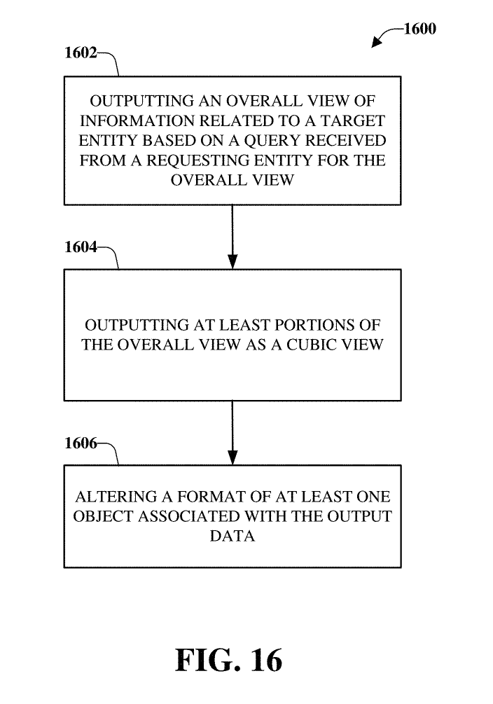

FIG. 16 illustrates a flow diagram of an example, non-limiting, computer-implemented method that facilitates outputting information related to a target entity in a virtual reality environment in accordance with one or more embodiments described herein;

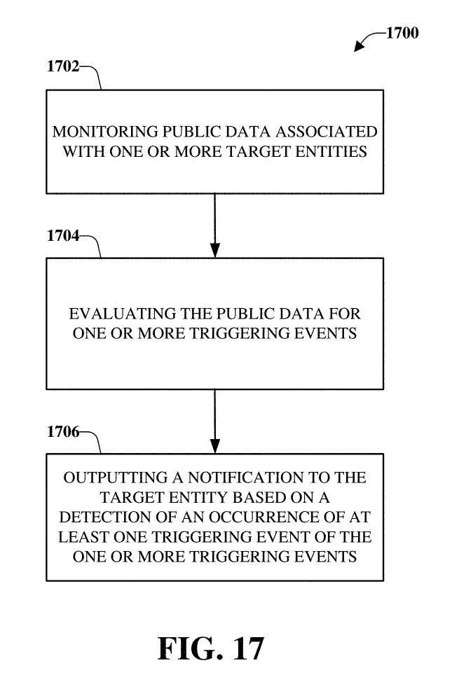

FIG. 17 illustrates a flow diagram of an example, non-limiting, computer-implemented method that facilitates providing one or more notifications based on detection of a trigger event in accordance with one or more embodiments described herein;

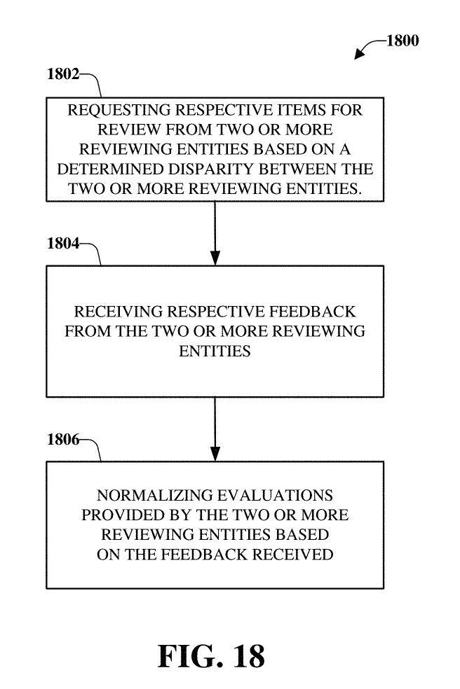

FIG. 18 illustrates a flow diagram of an example, non-limiting, computer-implemented method that facilitates normalization between first content associated with a first entity and second content associated with a second entity in accordance with one or more embodiments described herein;

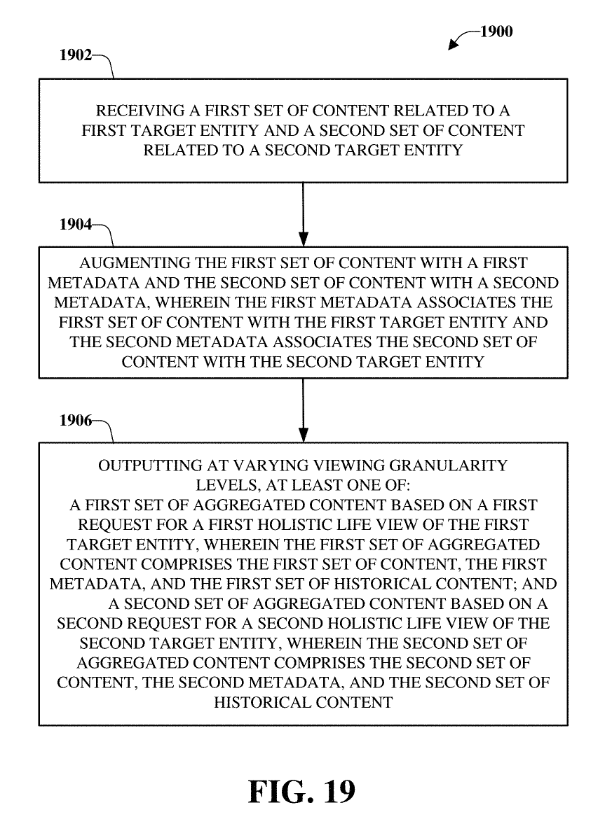

FIG. 19 illustrates a flow diagram of an example, non-limiting, computer-implemented method that facilitates providing respective holistic life views for one or more target entities in accordance with one or more embodiments described herein;

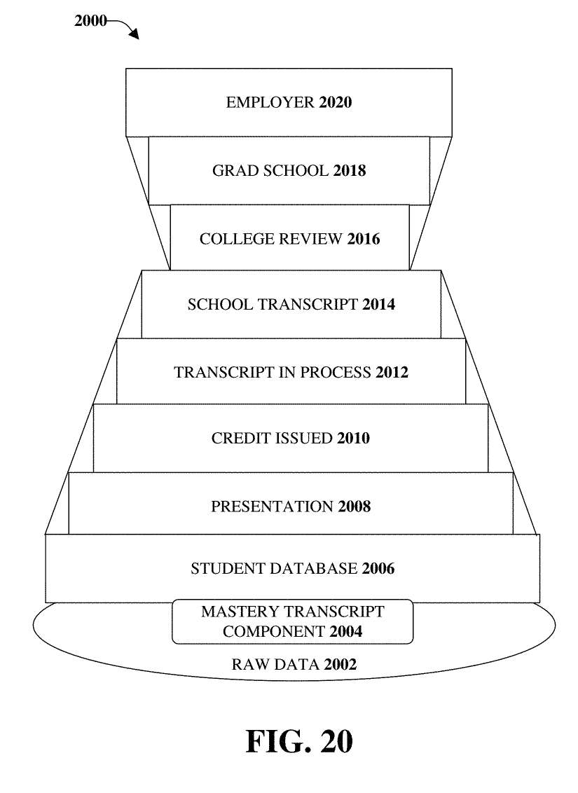

FIG. 20 illustrates an example, non-limiting, representation of various levels related to information and privacy in accordance with one or more embodiments described herein;

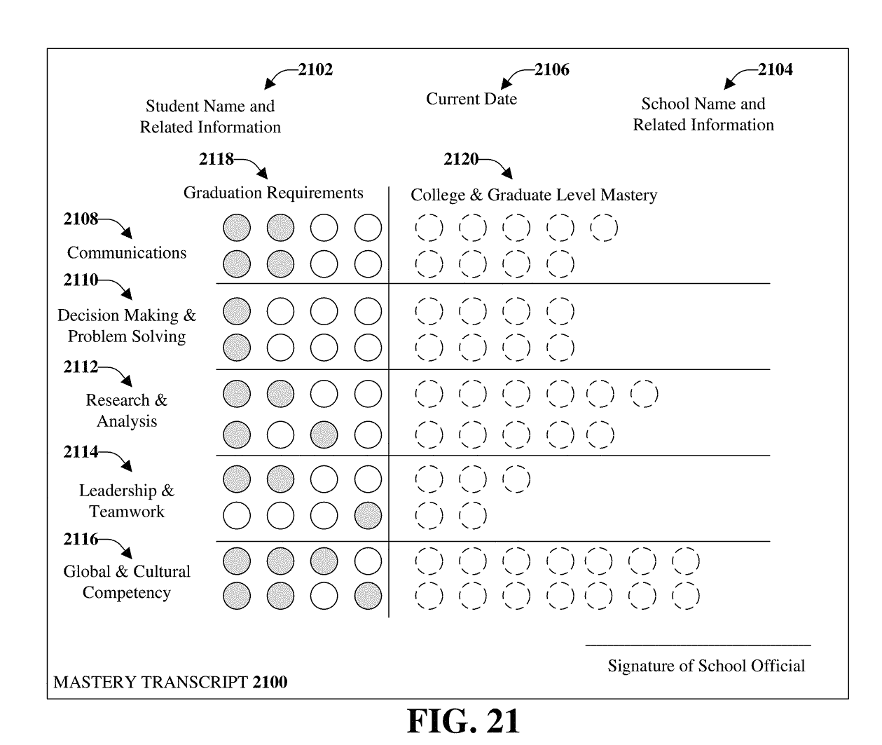

FIG. 21 illustrates an example, non-limiting, mastery transcript in accordance with one or more embodiments described herein;

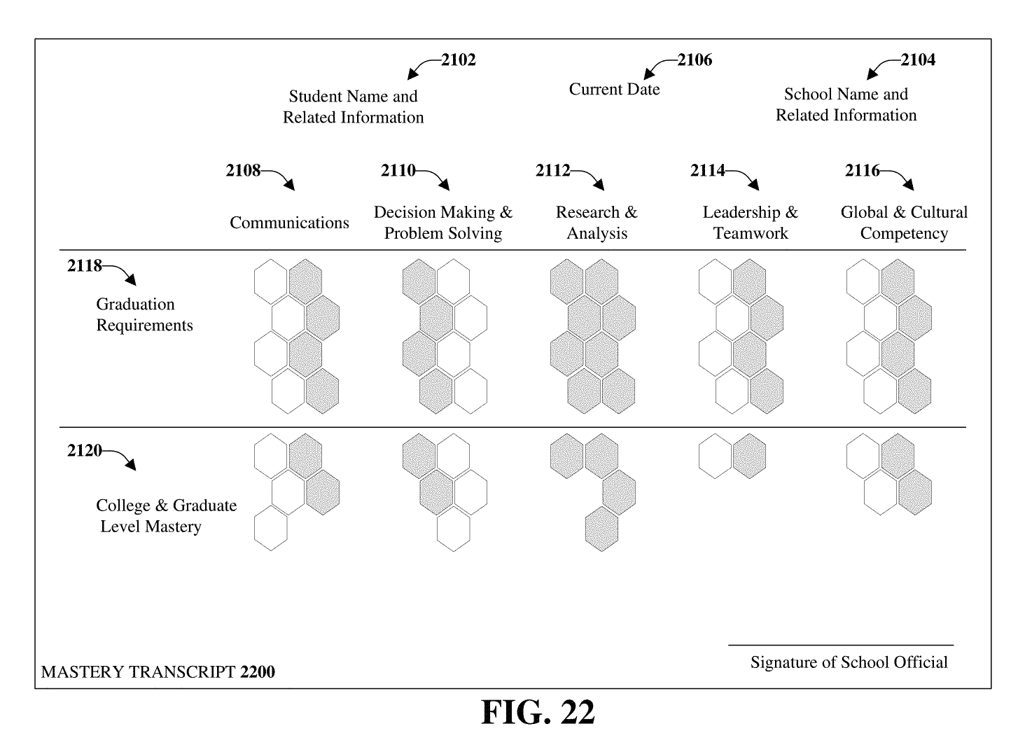

FIG. 22 illustrates an alternative example, non-limiting, mastery transcript in accordance with one or more embodiments described herein;

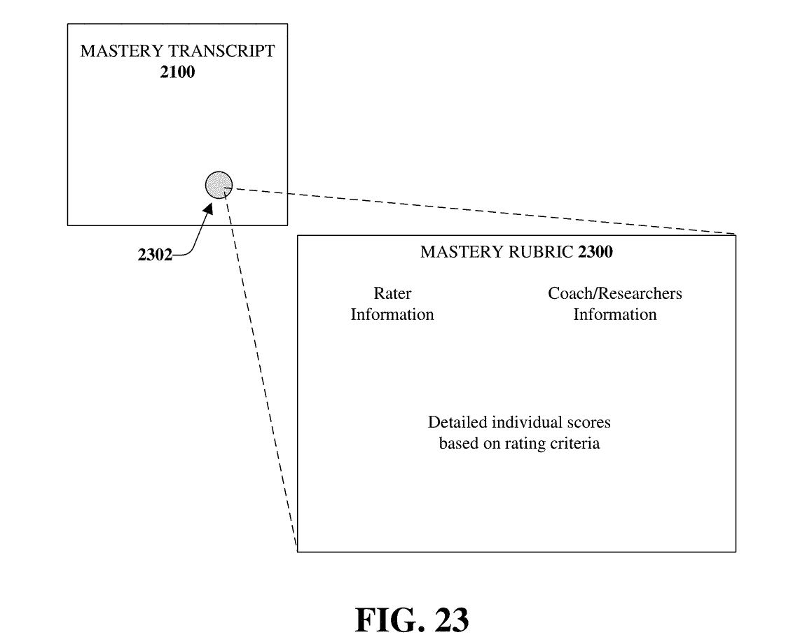

FIG. 23 illustrates an example, non-limiting, mastery rubric that provides detailed information for one micro-credit of the mastery transcript of FIG. 21 in accordance with one or more embodiments described herein;

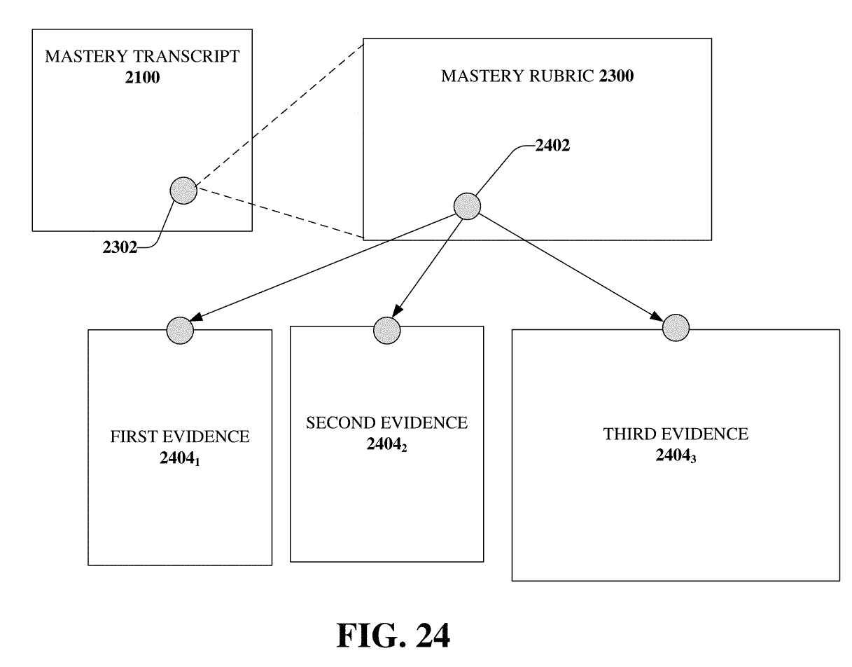

FIG. 24 illustrates example, non-limiting, portfolio evidence that provides further detailed information related to the mastery rubric of FIG. 23 in accordance with one or more embodiments described herein;

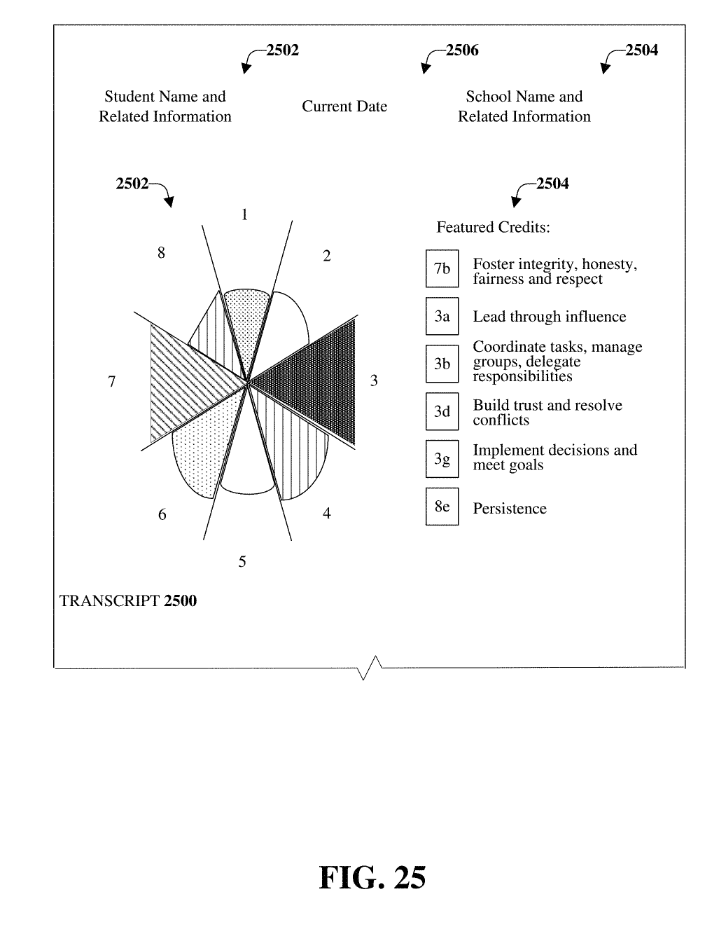

FIG. 25 illustrates a portion of an example, non-limiting transcript in accordance with one or more embodiments described herein;

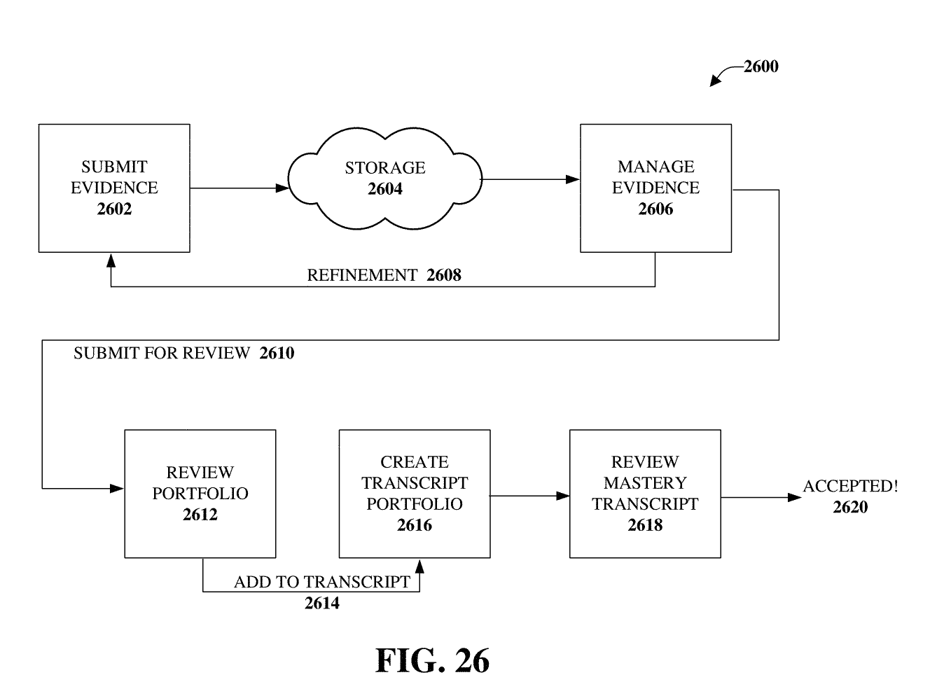

FIG. 26 illustrates an example, non-limiting technology platform flow that can be utilized in accordance with one or more embodiments described herein;

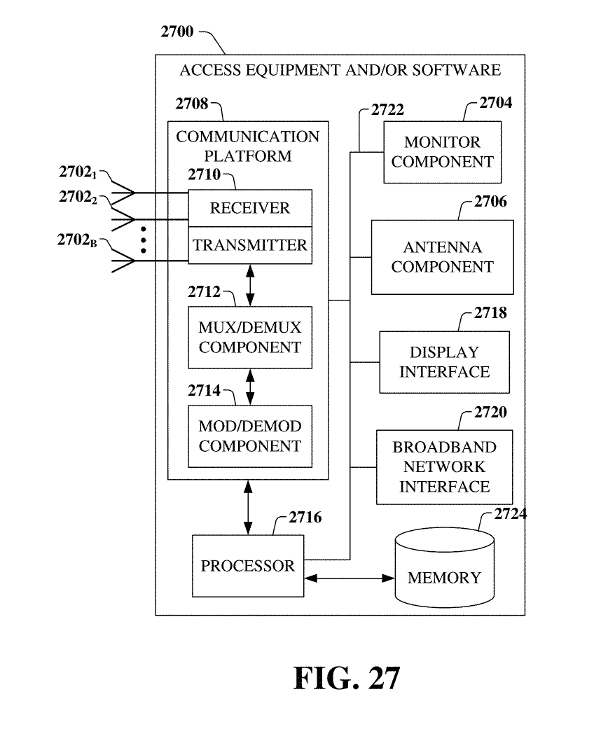

FIG. 27 illustrates a block diagram of access equipment and/or software related to access of a network, in accordance with one or more embodiments described herein;

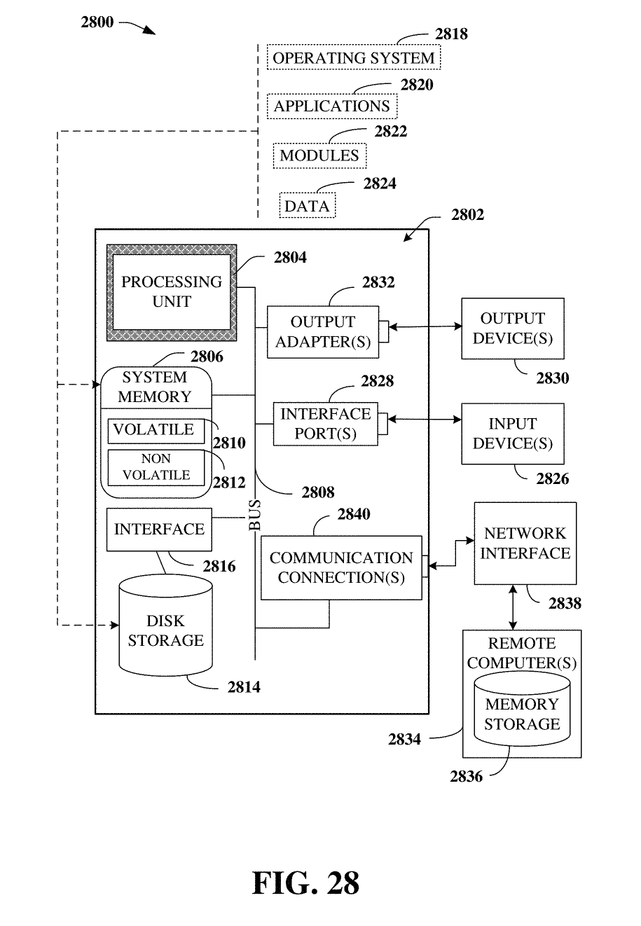

FIG. 28 illustrates a block diagram of a computing system, in accordance with one or more embodiments described herein; and

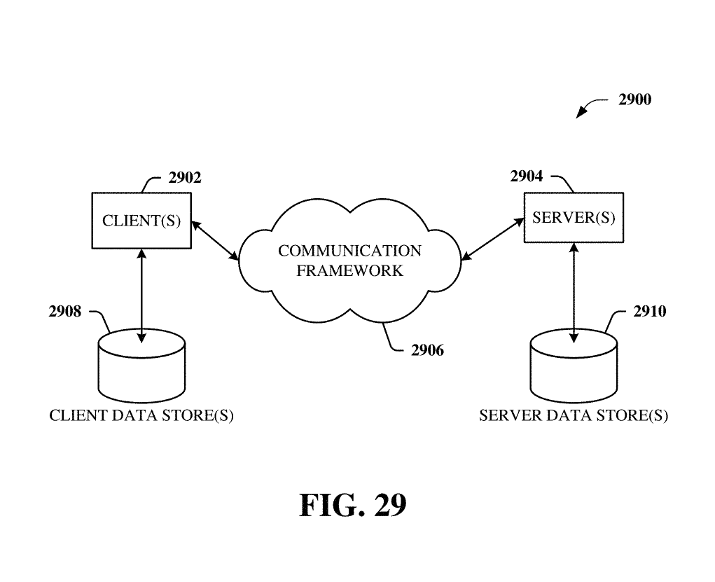

FIG. 29 illustrates an example, non-limiting, networking environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Embodiments described herein comprise systems, computer-implemented methods, and computer program products that can facilitate receiving disparate types of input data, from one or more sources, associated with one or more target entities. The disparate types of input data can comprise data that is in different formats (e.g., text, written words, typed words, speech, photos, videos) and/or input into different receiving applications and/or platforms (e.g., word processing applications, spreadsheet applications, drawing applications, video applications, social media platforms, and so on). The disparate types of input data can be transformed into a holistic, self-contained, reference database format that can be rendered at varying levels of granularity. Specifically, the transformation can include an in-depth analysis of the disparate types of input data in order to ascertain constitute elements of the input data. Further, the input data, divided into its constitute elements, can be characterize into meaningful categories, which can be selected and perceived at variable levels of granularity.

In further detail, the various aspects discussed herein can relate to an aggregation-based holistic data capture and analysis platform. There can be a voluminous amount of quantitative and qualitative information about one or more individuals, or groups of individuals, that can be captured in an electronic format, although the information could be originally in a non-electronic format. When reviewing information related to a particular individual, the viewer can be initially presented with a high-level (e.g., thirty-thousand-foot) view of the individual. In order to obtain a detailed view of one or more categories of information associated with the individual, the viewer can be provided the ability to drill down into one or more categories associated with the individual. In an example, the high-level view can be related to the high school years of the individual and the viewer can drill down into a particular class and discover what occurred in the class, the individual's goals for the class, assignments completed, comments from the teacher, comments from classmates, comments from the individual, and/or other information.

Further, the various aspects can facilitate aggregation-based qualitative assessment, according to some implementations. For example, as it relates to an educational setting, grading scales can provide a rank (e.g., a grading scale of “A” through “F”) of the student with respect to a certain item being measured (e.g., a test, a subject). However, the grading scale does not provide an accurate picture of what a student is really like, including their competency and mastery of the subject matter.

FIG. 1 illustrates a block diagram of an example, non-limiting, system 100 that facilitates aggregation-based qualitative assessment in accordance with one or more embodiments described herein. Aspects of systems (e.g., the system 100 and the like), apparatuses, or processes explained in this disclosure can constitute machine-executable component(s) embodied within machine(s), e.g., embodied in one or more computer readable mediums (or media) associated with one or more machines. Such component(s), when executed by the one or more machines, e.g., computer(s), computing device(s), virtual machine(s), etc. can cause the machine(s) to perform the operations described.

In various embodiments, the system 100 (and other systems discussed herein) can be any type of component, machine, device, facility, apparatus, and/or instrument that comprises a processor and/or can be capable of effective and/or operative communication with a wired and/or wireless network. Components, machines, apparatuses, devices, facilities, and/or instrumentalities that can comprise the system 100 can include tablet computing devices, handheld devices, server class computing machines and/or databases, laptop computers, notebook computers, desktop computers, cell phones, smart phones, consumer appliances and/or instrumentation, industrial and/or commercial devices, hand-held devices, digital assistants, multimedia Internet enabled phones, multimedia players, and the like. In addition, the system(s) and/or set of components discussed herein can be implemented, for example, in connection with a cloud-based, distributed, peer-to-peer, monolithic, isolated, or hierarchical framework.

In the embodiment illustrated in FIG. 1, the system 100 can comprise an aggregation engine 102, a processing component 104, a memory 106, and/or a storage 108. In some embodiments, one or more of the aggregation engine 102, the processing component 104, the memory 106, and/or the storage 108 can be communicatively and/or operatively coupled to one another to perform one or more functions of the system 100 and/or other systems.

The system 100 can receive input data 110, which can comprise various information related to one or more target entities. According to some implementations, the various information can be related. However, according to other implementations, the various information can represent separate pieces of information, which are not connected to one other (e.g., are related to two different events). Thus, the various information, supplied as input data 110, can be provided at a same time and/or at different times. In accordance with some implementations, the input data 110 can comprise information that can contribute to a holistic life view of a target entity.

Further, the various information can be provided in a multitude of formats including, but not limited to, electronic documents, electronic spreadsheets, electronic audio recordings, electronic video recordings (with or without audio), handwritten notes, drawings, sculptures, wood creations, metal creations, and so on. Accordingly, at least a set of the information can be in a physical format, features of which can be captured in an electronic format and provided to the system 100 as the input data 110.

According to some implementations, the various information can be received as input data 110 from respective computing devices associated with one or more source entities. For example, a wireless (or wired) communication can be established between a computing device providing the input data 110 and the system 100. As utilized herein an entity can be one or more computers, the Internet, one or more systems, one or more commercial enterprises, one or more computers, one or more computer programs, one or more machines, machinery, one or more actors, one or more users, one or more customers, one or more humans, and so forth, hereinafter referred to as an entity or entities depending on the context.

For purposes of explaining the various aspects, a target entity can be a student, an employee, or another individual about which information is obtained (e.g., the input data 110). Thus, the target entity can be the subject of at least a set of content contained in the holistic, self-contained, reference database. It is noted that the holistic, self-contained, reference database can contain information related to one or more target entities. The one or more target entities can be related (e.g., attend the same school, work for the same employer) or not related (e.g., job applicants applying from outside a company).

A source entity can be one or more computing devices associated with the target entity (e.g., the target entity can provide input data 110). Additionally, or alternatively, the source entity can be one or more other computing devices that obtains information related to the target entity. The one or more other computing device can obtain the information automatically or through a manual entry, such as at a computing device of an individual that is not the target entity.

In an example related to a classroom setting, the target entity can be a student and input data 110 can be received from one or more computing devices (e.g., one or more source entities) with which the student interacts (e.g., the student's mobile phone, the student's laptop, a computer accessible by the student in the school library, and so on). Further to this example, input data 110 can also be received from one or more other computing devices (e.g., one or more source entities) through which respective interaction is received from others, such as, for example, a teacher, a professor, administrative staff, an advisor, a counselor, a parent, or another individual (e.g., a fellow student, a sports coach, and so on).

The information received as input data 110 is not limited to a scholastic and/or employment setting. Instead, input data 110 can include information related to volunteer activities, civic organization participation, philanthropic involvement, and/or other information that the target entity (and/or a source entity) desire to input into the system 100. However, it is noted that the target entity can interact with the system (e.g., through a computing device) to mask or hide certain content of the reference database such that the information is not output to a viewer requesting the content. However, in situations where the viewer is the target entity, the masked content can be output, based on one or more configurable settings.

The input data 110 can comprise a machine-readable description of information associated with one or more target entities. For example, the input data 110 can be a machine-readable description of a document. In another example, the input data 110 can be a voice recording and/or video recording. In yet another example, the input data 110 can be a machine-readable description of a physical object. Further to this example, the input data 110 can comprise textual data indicative of a text-format language that describes the physical object. For example, the textual data can describe one or more physical objects sculptured by the target entity. In some implementations, a photograph of the physical object can be provided as the input data 110. Although various examples of input data 110 have been discussed herein, the disclosed aspects are not limited to these examples and other types of input data can be received for entry into the reference database.

Based on a request from a requesting entity, content of the reference database can be rendered as output data 112. As utilized herein, a requesting entity can be an entity that requested content (e.g., via a computing device). For example, the requesting entity can be the target entity, a source entity, or another entity. Thus, a communication between the system 100 and respective computing devices associated with one or more requesting entities can be established to provide the requested content (e.g., the output data 112). The output data 112 can be rendered in various levels of granularity (e.g., a viewing granularity). For example, the content can be initially provided at a high-level view and, based on one or more requests, certain portions of the output data 112 can be selected and rendered at a high-level of granularity (e.g., drill down into the content). The output data 112 can represent information (e.g., input data 110) gathered about the target entity over a large amount of time (e.g., can be captured over a lifetime of the individual, or at least a portion of the individual's life, such as school years, periods of employment, during leisure activities, or other times).

It is noted that in accordance with one or more implementations described in this disclosure, a target entity can opt-out of providing personal information, demographic information, location information, proprietary information, sensitive information, or the like in connection with data gathering aspects. Moreover, one or more implementations described herein can provide for anonymizing collected, received, and/or transmitted data. Further, a target entity can opt-out of providing information at any time, regardless of whether the target entity previously opted-in to providing the information.

The memory 106 can be operatively connected to the processing component 104. The memory 106 can store executable instructions that, when executed by the processing component 104 can facilitate performance of operations. Further, the processing component 104 can be utilized to execute computer executable components stored in the memory 106.

The memory 106 can store protocols associated with obtainment and categorization of a multitude of data related to one or more target entities, customization of the data, indexing of the data, search and retrieval of the data, and so on, such that the system 100 can employ stored protocols and/or algorithms to achieve improved communications and information in a communications network as described herein. It should be appreciated that data store (e.g., memories) components described herein can be either volatile memory or nonvolatile memory, or can include both volatile and nonvolatile memory. By way of example and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of example and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Memory of the disclosed aspects are intended to comprise, without being limited to, these and other suitable types of memory.

The processing component 104 can facilitate respective analysis of information related to the multitude of information received (e.g., the input data 110). The processing component 104 can be a processor dedicated to analyzing and/or categorizing information received, a processor that controls one or more components of the system 100, and/or a processor that both analyzes and categorizes information received and controls one or more outputs related to the multitude of input data 110 and/or output data 112.

It is noted that although various aspects are described and illustrated herein related to a single processing component, a single memory, and/or a single storage, the disclosed aspects are not limited to this example. Instead, more than one processing component, more than one memory, and/or more than one storage can be included in the system 100 (and/or other systems). Further, respective processing components, respective memories, and/or respective storages can be associated with one or more computing devices that provide the input data 110 and/or that receive the output data 112.

It is to be appreciated that the systems described herein (e.g., the aggregation engine 102, as well as other system components) can receive and perform a detailed analysis of disparate types of input data. The input data received can undergo a detailed analysis in order to categorize and/or index the input data, or portions of the input data. Based on the categorization, indexing, and/or other processing performed, the input data 110 can be transformed into a holistic, self-contained, reference database format. Further, content of the reference database can be rendered (as the output data 112) on demand and at various levels of granularity. It is noted that the input data 110, in addition to being in disparate formats, can be related to more than one target entity and can include a massive amount of information, received over time, on which detailed analysis and transformation into respective reference databases can be performed. This detailed analysis and transformation cannot be performed by a human (e.g., is greater than the capability of a single human mind). For example, an amount of data processed, a speed of data processed, and/or data types of data processed by the system 100 (e.g., the aggregation engine 102, as well as other system components) over a certain period of time can be greater, faster, and different than an amount, speed, and data type that can be processed by a single human mind over the same period of time. The system 100 (e.g., the aggregation engine 102, as well as other system components) can also be fully operational towards performing one or more other functions (e.g., fully powered on, fully executed, etc.) while also performing the above-referenced analytical and/or transformation processes. Moreover, the disparate types of input data coordinated by the system 100 (e.g., the aggregation engine 102, as well as other system components) can include a vast amount of information that can be impossible to obtain manually by a user. For example, a type of information included in the input data and/or the output data, a variety of information associated with the input data and/or the output data, and/or optimization of the input data to generate aggregated data that can be rendered as output data at various levels of granularity, which can be changed on demand, can be more complex than information that can be obtained manually and manually processed by a user.

In various embodiments, the system 100 can be a computing system associated with technologies such as, but not limited to, computing circuit technologies, computing processor technologies, artificial intelligence technologies, and/or other digital technologies. The system 100 can employ hardware and/or software to solve problems that are highly technical in nature, that are not abstract and that cannot be performed as a set of mental acts by a human. Further, in certain embodiments, some of the processes performed can be performed by one or more specialized computers (e.g., one or more specialized processing units, a specialized computer with an artificial intelligence computing component and/or a machine learning and reasoning computing component, etc.) to carry out defined tasks as discussed herein.

The system 100 and/or components of the system 100 (and/or other systems) can be employed to solve new problems that arise through advancements in technologies, computer architecture, and/or the like. One or more embodiments of the system 100 can provide technical improvements to computing systems, circuit systems, processor systems, artificial intelligence systems, and/or other systems.

For example, the one or more aspects discussed herein can improve the efficiency of using a communications device (e.g., a computer) by bringing together a multitude of disparate types of input data in a holistic, self-contained, reference database format, which can be accessed directly based on a request for at least a portion of the content of the reference database. The request can be properly authorized prior to release of the content. The content can be rendered such that categories of interest can be selected and further detail can be provided related to the selected content. For example, the viewer can initially be presented the selected content at a high-level view (e.g., a low level of granularity). The viewer can select a portion of the content, and can be presented that portion at a higher level of granularity. If additional detail related to the portion of the content selected is requested, further detail can be provided at an even higher level of granularity. Further, other content, not selected, can be hidden from view. Accordingly, the viewer can perceive the most relevant content at a higher level of granularity. Thus, the speed of the viewer's navigation through various categories can be improved because it saves the viewer from having to parse the large amount of content included in the reference database in order to obtain the desired content. Further, the speed of the viewer's navigation can be improved because the user can quickly drill-down into the content relevant to the viewer's request.

FIG. 2 illustrates a block diagram of an example, non-limiting, system 200 for facilitating aggregation-based qualitative assessment in accordance with one or more embodiments described herein. Repetitive description of like elements employed in other embodiments described herein is omitted for sake of brevity. The system 200 can comprise one or more of the components and/or functionalities of the system 100, and vice versa.

The system 200 can comprise one or more computer executable components, which can include a data manager component 202, an analysis component 204, a database 206, and an interface component 208. The data manager component 202 can obtain various information (e.g., the input data 110) related to one or more target entities). The one or more entities can be a student, an employee, or another individual about which information is gathered.

In an example, the data manager component 202 can receive input data 110, which can include information related to the target entity, from one or more source entities (e.g., via respective communication devices associated with the source entities). According to an implementation, the input data 110 can be received from a communication device associated with the target entity (e.g., the target entity is both the target entity and the source entity (e.g., a target/source entity)). In an alternative or additional implementation, the input data 110 can be received from one or more communication devices associated with entities other than the target entity (e.g., one or more source entities). For example, a student can provide information (e.g., via one or more communication devices) and/or a teacher, advisor, parent, or other individual can provide information (e.g., via respective communication devices). The information provided by the various entities can be the same information, similar information, information gathered from alternative perspectives, or different information. Further, the information received from the target/source entity and/or the source entities can be received at substantially the same time and/or at different times. For example, information can be provided by a same source (e.g., a source entity) over a long period of time (e.g., years). A wireless (or wired) communication can be established between the system 200 and the respective communication devices (or computing devices) in order to facilitate the information exchange.

According to some implementations, the data manager component 202 can obtain the information directly. For example, the data manager component 202 can be operatively coupled to one or more cameras or other image capture devices, one or more microphones, one or more sensors, or other types of information gathering devices. In some implementations, one or more computing devices associated with the target entity and/or one or more source entities can dynamically or automatically submit information to the data manager component 202, which can be established based on defined preferences.

The information obtained can be retained in the database 206 (e.g., a reference database). According to some implementations, the database 206 can be included at least partially in the system 200. However, in some implementations, the database 206 can be retained, at least partially, in the “cloud” according to a cloud computing infrastructure. In addition, although shown and described with respect to a single database, multiple databases can be utilized with the disclosed aspects. Further, although illustrated and described separate from the storage 108, the database 206 can be included, at least partially, in the storage 108 (or another system component).

The various aspects discussed herein can facilitate gathering a wide-variety of information related to a target entity. Although the various aspects are discussed with respect to the target entity being an individual (e.g., a student, an employee), alternatively, the target entity could be a company, a non-profit organization, and so on, about which information can be obtained. In an example related to a student, the various aspects can facilitate that every (or a large amount) of product produced by the student can be retained in the database 206. The product can include homework assignments, tests, reports, speeches, interaction with other students, interactions with teachers, interactions with others within the school, and/or other items. Physical items (e.g., handwritten stories, handwritten tests, class outlines, speech outlines, drawings, notes, teacher's notes, and so on) can be electronically scanned and saved within the database 206. Other physical items that cannot be electronically scanned (e.g., wall murals, paintings, sculptures, woodcraft objects, metal objects, and other items created by the student) can be electronically captured in one or more dimensions, such as with a camera, and electronically input into the database 206. Further, other items associated with the student can be recorded through video and/or audio and saved within the database 206.

The analysis component 204 can evaluate the incoming information (e.g., the input data 110) and determine a subject matter of the information. For example, the input data 110 can be evaluated to determine a target entity associated with the input data 110, a topic of the input data 110, and/or other data associated with the input data 110. The analysis component 204 can apply one or more metadata to the information, wherein the metadata describes the subject matter of the information. The metadata can be utilized for ease of retrieval of the information. The metadata associated with the information can include descriptive metadata, structural metadata, and/or administrative metadata. The metadata or other information can be utilized for discovery of the information based on a request or search for the information. For example, content associated with a target entity can be indicated as containing related information (e.g., via the use of metadata). In another example, content associated with a similar subject matter can be indicated as containing related information (e.g., via the use of metadata).

Based on a request for content (e.g., a defined search criteria) received from requestor (e.g., the requesting entity), the system 200 can facilitate output of the requested information (e.g., the output data 112) in differing levels of granularity. In an example, the output can be facilitated via the interface component 208. For example, the requesting entity can be initially presented with an overall view (e.g., a thirty-thousand-foot view) of all information associated with the target entity (or other search criteria). Upon or after review of the information presented (e.g., the overall view), the requesting entity can be provided the option to drill-down into one or more constitute elements of the overall view. Drilling down into the constitute elements can provide the requesting entity with a higher granularity related to the subject matter of interest. Specific examples related to the differing levels of granularity are illustrated and described below with respect to FIGS. 21 through 25.

The determination of the data to output (e.g., the output data 112) can be based on the metadata. Further, the data that is output can be a portion of the data retained in the database 206, wherein other data is not output (e.g., can be associated with a different target entity, a different subject matter, or is otherwise not related to the received search criteria).

FIG. 3 illustrates a block diagram of an example, non-limiting, system 300 for facilitating categorization of accumulated data in accordance with one or more embodiments described herein. Repetitive description of like elements employed in other embodiments described herein is omitted for sake of brevity. The system 300 can comprise one or more of the components and/or functionalities of the system 100 and/or the system 200, and vice versa.

In an example, the system 300 (as well as other aspects discussed herein) can facilitate a “living, breathing” database of information related to a target entity. The term “living, breathing” indicates that the system 300 is not static. Instead, the system 300 can be dynamic such that information contained in the database can be continually augmented. For example, data can be added, deleted, notated, modified, explained, categorized, and/or other functions can be applied to the data.

In an example instance of a student, the database 206 can include every (or almost all, such as a subset of) homework assignments prepared by the student, tests taken by the student, reports written by the student, and so on. The database 206 can also include analysis and/or evaluation of the student, which can include work prepared by the student, performance of the student as evaluated by another individual, observations by another individual, and so on. Further, one or more instructors (e.g., source entity) can provide a qualitative assessment of the student regarding mastery of a particular subject, the student's character, the student's attitude, and other information related to the student. This data can be captured over the student's lifetime (e.g., can extend beyond the school years). It is noted that although specific examples of data that can be included in the database 206 are discussed, the disclosed aspects are not limited to these examples. Instead, the database 206 can contain a large assortment of information, which can be limited only by what is received as input data 110.

In another example instance of an employee, the employee (e.g., the target entity) can input data related to the employee's job (e.g., certifications awarded, emails received and/or sent, information related to projects worked on, days and/or hours worked). In addition, the employee's supervisor and/or other personnel in the company (e.g., human resource personnel, management personnel, subordinate, co-workers, outside vendors, and so on) can input data related to the particular employee. Examples of input data 110 can include, but is not limited to, an amount of sales generated by the employee, a production level of the employees, monthly status reports written by the employee, inventions created by the employee, patents written by the employee, and so on. As mentioned above, the disclosed aspects are not limited to these specific examples of input data.

The system 300 of FIG. 3 can comprise various computer executable components including a correlation component 304, an index component 306, a security component 308, and an output component 310. The memory 106 can store computer executable components and instructions. The processing component 104 (e.g., a processor) can facilitate execution of the instructions (e.g., computer executable components and corresponding instructions) by the correlation component 304, the index component 306, the security component 308, and the output component 310, and/or other components of the system 300 and/or other systems discussed herein. As illustrated, in some embodiments, one or more of the correlation component 304, the index component 306, the security component 308, the output component 310, the processing component 104, the memory 106, and/or the storage 108, and/or other components of the system 300 (and/or other systems discussed herein) can be electrically, communicatively, and/or operatively coupled to one another to perform one or more functions of the system 300 (or other systems).

The data manager component 202 can receive the input data 110. According to some implementations, the input data 110 can be obtained directly or indirectly by the data manager component 202. For example, the data manager component 202 can be operatively coupled to one or more cameras or other image capture devices, one or more microphones, one or more sensors, and/or other types of information gathering devices. In some implementations, one or more computing devices associated with the target entity and/or respective computing devices associated with the one or more source entities can dynamically (e.g., without manual intervention from one or more individuals) submit information to the data manager component 202. For example, a computing device can be configured to automatically submit information based on detection of an event (e.g., presence of a target entity, location of the computing device (e.g., in a specific classroom), detection of one or more key words or phrases, and so on. To convey information, a communication link can be established between the data manager component 202 (or the system 200) and the devices (e.g., information gathering devices, computing devices, and so on) can provide the input data 110 via the communication link.

In an example, the analysis component 204 can associate one or more input data 110 with a target entity, two or more target entities, a subject matter, a location, and so on. Thus, as input data 110 is received and retained in the database 206, the correlation component 304 can cross-reference the respective input data with data previously retained in the database 206 based, at least in part, on respective metadata associated with the input data and the historical data (e.g., the metadata indicates the information comprises related content). As one example, the previously retained data can be historical data about the one or more target entities. An indication of how to cross-reference the input data 110 can be received directly by the correlation component 304 (e.g., based on defined rules and/or policies, based on one or more defined preferences, and so on). However, according to some implementations, the indication of how to cross-reference the input data 110 can be inferred by the correlation component 304 based on historical information, based on how data has historically been cross-referenced, and so on.

Based on the evaluation, the correlation component 304 can determine stored information (e.g., previously received) and newly acquired information (e.g., the input data 110) are related and can aggregate the related content. In an implementation, the correlation component 304 can aggregate the related content based on the metadata applied by the analysis component 204. In some implementations, the correlation component 304 can aggregate the content based on a search criterion received from the requesting entity (e.g., via the interface component 208). The aggregation of the data can facilitate an output of the data as an overall view (e.g., the thirty-thousand-foot view) and, thus, the output data 112 can be aggregated output data. However, according to other implementations, the correlation component 304 can aggregate the content within the database 206 (e.g., prior to a request for the content).

According to some implementations, the correlation component 304 can cross-reference a first set of data with at least a second set of data. For example, data that is not related (e.g., based on the metadata) can be associated with one another based on other parameters (e.g., information gathered during a same classroom experience, information gathered during a yearly work conference, and so on). Thus, when the data is output, an indication that the output data 112 is related to other (non-output data) can be rendered and could be useful to clarify one or more portions of the output data 112.

The index component 306 can applies an indication to the data, wherein the indication specifies how the data should be output. The target entity can provide one or more preferences for indexing (e.g., outputting) the data. For example, the information can be indexed, by the index component 306, based on a time stamp associated with the information (e.g., a date indicating when the information was created and/or when the information was received). Data indexed by date can provide a progression of the target entity. Thus, the data can be output in a chronological order, a reverse chronological order, or in ranges of dates (e.g., years, months, school level, and so on).

In another example, the information can be indexed, by the index component 306, based on customized information (e.g., a student selects her top five reports), or based on other parameters. Data indexed by customized information can facilitate a rendering of the output data 112 with an emphasis on the indexed content. For example, the top five reports can be output first, or can be output in a manner that emphasizes the indexed content (e.g., displayed in a larger size than other content, displayed in a different color than other content, and so on).

The security component 308 can restrict access to content in the database 206 to one or more requesting entities. For example, the content available for consumption by the requesting entity can be based on one or more rendering criteria (e.g., credentials of the requesting entity, a security level associated with the content, a completion level of the content, preferences of the target entity, and so on). Thus, according to some implementations, the rendering criteria can be controlled by the target entity. For example, the target entity can establish criteria (enforced by the security component 308) that only specific individuals are able to access the content of the target entity. In another example, the target entity can establish criteria (enforced by the security component 308) that a first set of content is viewable to all requestors, a second set of content is retrievable only for selected requestors, and a third set of content is retrievable only the by the target entity. Thus, the target entity is able to control out the output component 310 presents the output data 112.

FIG. 4 illustrates a block diagram of an example, non-limiting, system 400 for facilitating aggregation-based qualitative assessment in accordance with one or more embodiments described herein. Repetitive description of like elements employed in other embodiments described herein is omitted for sake of brevity. The system 400 can comprise one or more of the components and/or functionalities of the system 100, the system 200, and/or the system 300, and vice versa.

As illustrated, the system 400 can comprise a search component 402, a filter component 404, a zooming component 406, and a modification component 408 (e.g., computer executable components). The data manager component 202 can facilitate receipt of the input data 110 by the system 400. For example, the data manager component 202 can obtain input data 110 from one or more computing devices associated with the target entity and/or one or more source entities. For example, the target entity can be associated with (e.g., can interact with) a first computing device and a source entity can be (or can interact with) a second computing device. According to some implementations, the data manager component 202 can receive input data that is related to two or more target entities (e.g., co-authors of a paper, co-inventors, classmates, co-workers, and so on.)

The input data 110 can be electronically scanned by (and received from) respective computing devices of the target entities and/or source entities. In some implementations, the input data 110 can be captured through other means (e.g., sensors, cameras, Internet searches, and so on). The input data 110 can be categorized as discussed herein (e.g., via the analysis component 204, the correlation component 304, the index component 306, and/or other system components) and stored as historical data in the database 206.

Newly received input data 110 can be cumulative to other data already received (e.g., historical data) over time (e.g., days, months, years, decades, and so on). According to an example, input data 110 can be received at various times (e.g., hourly, daily, weekly, monthly, over the years, based on an occurrence of an event, and so on). In an example, information related to a student can be captured throughout the years of education of the student (e.g., from pre-school through graduate school). Further, information related to an employee's work performance can be added to the information collected when that employee was a student (e.g., the scholastic activities).

The output component 310 can interact with the interface component 208 to facilitate a rendering of at least a subset of the aggregate data (e.g., the output data 112) based on a request for the data. The rendering of at least the subset of the aggregate data can be performed at respective devices of one or more requesting entities. For example, a requesting entity can be the target entity and/or another entity that has approval to access the aggregate data associated with the target entity (e.g., as determined by the security component 308). According to some implementations, the requesting entity can be one or more advertisers that can provide targeted advertisements to the target entity based on data exposed to the one or more advertisers (with the permission of the target entity).

For example, through an interaction facilitated between the interface component 208 and a computing device associated with the requesting entity, the requesting entity can selectively retrieve data (e.g., the output data 112) from the database 206, based on one or more search criteria (and based on one or more viewing credentials determined by the security component 308). The interaction with the interface component 208 can be based on an input received at a computing device associated with the requesting entity, wherein establishment of a communication between the computing device and the system 400 is performed.

In an example, the output component 310 can provide a menu to access the content of the database 206. For example, the menu can provide a listing for different categories. According to some implementations, the menu can facilitate selection between different formats (e.g., audio, video, images, text, and so on).

Upon or after the request is received, the search component 402 can facilitate retrieval of the data indicated in the one or more search criteria. In an example, the request can be for information related to a defined entity (e.g., the target entity). Based on this request, the metadata information, the index information, and/or the cross-reference information can be utilized to gather the data associated with the defined entity (e.g., the target entity). Thus, an aggregate of all data available that satisfies the one or more search criteria can be rendered by the output component 310 and/or the interface component 208.

According to some implementations, the parameters of a request for data can be based on an inference. For example, the request can be from a device associated with the target entity and, based on information known about the computing devices utilized by the target entity (e.g., historical information), the search component 402 can dynamically perform a search of the database 206 for data related to the target entity.

In another example, the search criteria (e.g., received by the interface component 208) can be for the creative writing authored by a defined target entity. Based on the request, the content can be accessed from the database 206 and the interface component 208 can facilitate the rendering of the creative writing associated with the target entity that is available for consumption by the requesting entity (as determined by the security component 308).

It is noted that the database 206 can retain a tremendous amount of data related to one or more target entities. Therefore, even when the data is cross-referenced and indexed, there can be a large amount of data available as the output data 112. Accordingly, the filter component 404 can provide the requesting entity the ability to filter the large amount of data based on what the requesting entity is interested in learning more about (e.g., a science class). Therefore, the requesting entity does not spend time looking at something that is not of interest.

For example, a particular category of data can relate to a science class. In another example, the particular category of data can relate to a specific achievement (e.g., speech contests and related outcomes). To facilitate the focus or target of the aggregated data (e.g., the output data 112) to a particular category, a dialog can be facilitated by the filter component 404 to a computing device associated with the requesting entity (e.g., via the interface component 208). The dialog can be in a question and answer format and/or can include a request for a category of data requested, a time frame, a subject, or other information that can be utilized by the filter component 404 to narrow the search.

After the relevant data to render as the output data 112 is determined, the data can still be at a high-level and the requesting entity could further want to narrow the data viewed. Accordingly, the zooming component 406 can facilitate the selective targeting of a particular category of data for output as the output data 112, which can be at different levels of granularity.

According to an example related to a science class, by further zooming in or focusing with the zooming component 406, it is possible to access the teacher's comments about the student, projects or reports turned in by the student, and/or other elements of the science class. The zooming component 406 can facilitate viewing of the reports and more in-depth information related to the various aspects of the science class. The zooming component 406 can also allow the requesting entity to return to a lower level of granularity and change the focus of the tailored search in order to look at another category (e.g., an art class, an employment history, and/or other items associated with the target entity). Specific examples related to the differing levels of granularity are illustrated and described below with respect to FIGS. 21 through 25.

According to some implementations, since the database 206 can comprise a massive amount of data, the analysis component 204 can provide a categorization to the respective items of data, or portions of the items of data. For example, the categorization can be a broad categorization (e.g., “school,” “employment”). A next category of categorization can be narrower (e.g., “history class, sixth grade,” “apprentice helper”). Still another category can relate to specific day(s). However, it should be understood that a multitude of categories of various degrees of specificity can be utilized with the disclosed aspects and are not listed here for purposes of simplicity. Further details related to the different categorization levels illustrated and described below with respect to FIGS. 21, 23, and 24.

In an example, to focus on the relevant data at a desired level of granularity, the requesting entity can interface with the search component 402, the filter component 404, and/or the zooming component 406 (e.g., via the interface component 208) by utilizing the metadata, index, or other information associated with the data. The filter component 404 can facilitate filtering out data that is not relevant to a search query, which can allow the requesting entity to quickly retrieve the items of interest. According to some implementations, the interaction with the search component 402 (e.g., via the interface component 208) can be performed during a visual rendering of the data (e.g., as illustrated and described below with respect to FIGS. 21, 23, and 24). In another example, the interaction with the search component 402 (e.g., via the interface component 208) can be performed as a traditional Boolean query or other type of query. The output, via the interface component 208 and/or the output component 310, can be in various formats including, but not limited to, a pie chart that can be pivoted in a multitude of different directions.

The modification component 408 can facilitate selective customization or modification of the data. For example, the target entity, as the owner of the data that is associated with the target entity, can retract one or more items of data that s/he does not want shared with others. In another example, the target entity can append data to the information contained in the storage 108. For example, the information can be appended with notes or comments explaining certain data, an indication to look at another item that might provide more information, and so on. Further, the target entity can add data to the database 206 through an interaction with the modification component 408.

To facilitate the modification of the data by the target entity (or another authorized entity), the modification component 408 can provide one or more tools for performing the modifications. The one or more tools can be software code that facilitate the selection of, and modification to, data associated with the target entity. The term “tool” as utilized herein is not meant to limit the disclosed aspects to a particular computing platform and/or a particular computing program. Instead the term “tool” is utilized as indicating that the various aspects can provide assistance for facilitating the modification (including additions and deletion of data). Examples of tools that can be provided will be discussed in further detail with respect to FIG. 20, for example.

According to some implementations, the interface component 208 (as well as other interface components discussed herein) can provide a graphical user interface (GUI), a command line interface, a speech interface, Natural Language text interface, and the like. For example, a Graphical User Interface (GUI) can be rendered that provides a user (e.g., the target entity, the source entity, the requesting entity) with a region or means to load, import, select, read, and so forth, various requests and can include a region to present the results of the various requests. These regions can include known text and/or graphic regions that include dialogue boxes, static controls, drop-down-menus, list boxes, pop-up menus, as edit controls, combo boxes, radio buttons, check boxes, push buttons, graphic boxes, and so on. In addition, utilities to facilitate the information conveyance, such as vertical and/or horizontal scroll bars for navigation and toolbar buttons to determine whether a region will be viewable, can be employed. Thus, it might be inferred that the user did want the action performed.

The user can also interact with the regions to select and provide information through various devices such as a mouse, a roller ball, a keypad, a keyboard, a pen, gestures captured with a camera, a touch screen, and/or voice activation, for example. According to an aspect, a mechanism, such as a push button or the enter key on the keyboard, can be employed subsequent to entering the information in order to initiate information conveyance. However, it is to be appreciated that the disclosed aspects are not so limited. For example, merely highlighting a check box can initiate information conveyance. In another example, a command line interface can be employed. For example, the command line interface can prompt the user for information by providing a text message, producing an audio tone, or the like. The user can then provide suitable information, such as alphanumeric input corresponding to an option provided in the interface prompt or an answer to a question posed in the prompt. It is to be appreciated that the command line interface can be employed in connection with a GUI and/or an Application Program Interface (API). In addition, the command line interface can be employed in connection with hardware (e.g., video cards) and/or displays (e.g., black and white, and Video Graphics Array (EGA)) with limited graphic support, and/or low bandwidth communication channels.

FIG. 5 illustrates an example, non-limiting, system 500 that provides a virtual reality view of data in accordance with one or more embodiments described herein. Repetitive description of like elements employed in other embodiments described herein is omitted for sake of brevity. The system 500 can comprise one or more of the components and/or functionalities of the system 100, the system 200, the system 300, and/or the system 400, and vice versa.

As discussed herein, various aspects can facilitate gathering a wide-variety of information related to a target entity (e.g., an individual, such as a student or an employee, or an entity, such as a company, non-profit organization, and so on). In an example related to a student, the various aspects can provide a database and every (or a large amount) of product produced by the student can be retained in the database 206. The product can include homework assignments, tests, reports, speeches, interaction with other students, teachers, and/or others within the school. The physical items (e.g., handwritten stories, handwritten tests, class outlines, speech outlines, drawings, and so on) can be electronically scanned and saved within the database 206. Other physical items that cannot be electronically scanned (e.g., wall murals, paintings, sculptures, woodcraft objects, metal objects, and other items created by the student) can be electronically captured in one or more dimensions, such as with a camera, and electronically input into the database 206. Further, other items associated with the student can be recorded through video or audio and saved within the database 206. A requesting entity can perceive an aggregation of the data related to one or more specific areas and, starting from a high-level view of the data available, a determination can be made whether the target entity has mastered something or not based on a review of the data at various levels of granularity.

In accordance with one or more embodiments, the output component 310 can facilitate a rendering of the aggregated data as the output data 112 based on a request for the data. The output component 310 can facilitate the rendering of the aggregated data in various perceivable formats (e.g., visual, audible, tactile, and so on). For example, the output component 310 can facilitate the output of the data at a computing device associated with an entity requesting the data. According to some implementations, the rendering of the output data 112 can be based on credentials associated with the entity requesting the data and/or based on a prior approval that the data can be released to a defined entity. For example, the owner of the data can be the target entity. Thus, the target entity can control his own data.

The system 500 can include a virtual reality component 502 that can provide a virtual environment experience format where a requesting entity (e.g., an evaluator or person in college admissions) can “walk” through a virtual world from the perspective of the target entity. For example, the virtual environment experience format provided by the virtual reality component can initialized at a high-level and selectively altered based on a request for detailed artifacts related to a defined portion of the aggregated information (e.g., a combination of information related to the target entity as determined based on metadata associated with the information).

According to an implementation, the virtual world can be created by the target entity and/or can be based on information about the target entity retained in the database 206. In an implementation, the requestor can utilize a wearable device (e.g., goggles, glasses, or another wearable device) that provide a unique experience where the requestor enters the target entity's world. This can be similar to a life-view of the target entity.

As discussed, a requesting entity can be presented with an overall view, which can be selectively drilled into (e.g., zoomed into) to obtain more granular information associated with a target entity. In an example, the granular information can be presented as a cubic view, wherein the selected information is segregated from the other available information. According to an implementation, the cubic view can be in the form of virtual rooms that the requestor can virtually enter to perceive compartmentalized information. The virtual reality component 506 can allow the requestor to open doors into different areas. In another implementation, the information can be viewed from above and rotated to discover other information and drill into that information.

In an example of a school setting, different doors can be related to different subject areas (e.g., art, science, math, history, and so on). The perspective provided by the virtual reality component 504 can be an immersive environment that allows the evaluator to glean a lot of information about the student very quickly.

In an example, by interacting with the virtual reality component 502, the requesting entity can be virtually standing in the database 206. Each space (e.g., room, cube) can provide insight as to what the student is learning. For example, a space can be related to a single topic, category, item of interest, time period, and so on.

According to an implementation, the space viewed can be from the perspective of the student. According to other implementations, the space viewed can be from the perspective of another person observing the student. The virtual reality component 502 (separately or in conjunction with the interface component 208) can immerse the requesting entity in a rich experience to more fully observe and learn details of the target entity. The immersion by the virtual reality component 502 can provide a level of knowledge of the target entity that is not available by just reviewing the information in a static environment.

According to an implementation, the virtual reality component 502 (e.g., through interaction with the output component 310 and/or the interface component 208) can alter a format of the output data 112 in order to allow the requesting entity to feel as if s/he is immersed in the data. For example, the virtual reality component 502 can render documents in a format that appears as if the documents are on the walls of a room (and can appear to be enlarged documents, rather than paper sized (e.g., 8.5″×11″) documents). Therefore, as the viewing entity virtually walks around the room, the viewing entity can perceive the documents on the walls. In another example, the virtual reality component 502 can render pictures of objects in a three-dimensional (3D) format, to allow the viewing entity to virtually walk around the objects, rather than viewing a still image. In yet another example, videos can be running a debate video of the target entity. Another virtual room can be a credit room and, on each of the walls is the best material produced by the target entity.

FIG. 6 illustrates an example, non-limiting, system 600 that incorporates input entity assessment in accordance with one or more embodiments described herein. Repetitive description of like elements employed in other embodiments described herein is omitted for sake of brevity. The system 600 can comprise one or more of the components and/or functionalities of the system 100, the system 200, the system 300, the system 400, and/or the system 500, and vice versa.

The system 600 can include a mastery component 602 that can evaluate or assess reviews (or other notes) about the target entity as submitted by one or more source entities. According to some implementations, a source entity can be a teacher. As the teacher is tagging items and other data in real-time, a reference to the specific teacher can be included in a school transcript, by the mastery component 602, according to one or more aspects.

The mastery component 602 can compile (e.g., separately or in conjunction with the correlation component 304) the various forms of feedback, such as notes the teacher has written about the student, comments the teacher has about the student, and so on. The mastery component 602 can pull the various forms of feedback across all teachers and others at the school that have provided input about the student. The feedback can be organized (e.g., by the index component 306) such that the feedback can be quickly reviewed. For example, the feedback can be organized based on school year, based on general subject areas, and/or based on other categories of information.

In an example, the mastery component 602 can incorporate the feedback into a school transcript (e.g., in an electronic format). The school transcript can be in a format that is understandable by the requesting entities. For example, the format can be a standard format utilized across disparate viewing entities (e.g., across the different colleges). According to some implementations, the mastery component 602 can tailor the school transcript to respective preferences of the one or more requesting entities. The preferences can be determined a priori. However, according to some implementations, the preferences can be determined by the mastery component 602 at about the same time as the school transcript is requested and/or output (e.g., based on a dialog between the system 600 and the requesting entity).

The feedback can be included as a separate window or panel within the electronic transcript. In one example, the feedback can be included in a side panel and the viewer can scroll through the feedback. By providing the feedback in a separate window, the viewer can more easily drill into the portions of feedback that are of interest. In such a manner, the transcript and feedback can be provided in a single view (e.g., without the need to scroll through different screens).

In an example, the filter component 404 can select the feedback that is output (e.g., the output data 112). Thus, depending on the criteria, the feedback provided as a portion of the output data 112 can include information related to, for example, creative writing prepared by the student, observations related to the reasoning of the student, observations related to performance areas, and so on. In some implementations, the feedback can include the teacher's comments. However, in other implementations the teacher's comments are replaced, anonymized, and/or aggregated with other comments.

FIG. 7 illustrates an example, non-limiting, system 700 that facilitates interaction between a requesting entity and data contained in a holistic view in accordance with one or more embodiments described herein. Repetitive description of like elements employed in other embodiments described herein is omitted for sake of brevity. The system 700 can comprise one or more of the components and/or functionalities of the system 100, the system 200, the system 300, the system 400, the system 500, and/or the system 600, and vice versa.

Included in the system 700 can be an interaction component 702 that can determine how a viewer (e.g., requesting entity) perceives the data (e.g., the output data 112) and can provide data that is determined to be more relevant to the viewer. According to an implementation, the interaction component 702 can communicate with a computing device associated with the viewer. The computing device can provide information to the interaction component 702 related to preferences of the viewer, historical information associated with the viewer and how the viewer has historically perceived data, an amount of time (e.g., how long) the viewer perceives the data, what the viewer does after perceiving the data, and so on.

According to an example, it could be determined that a particular viewer only scans sets of data for a limited amount of time (e.g., ninety seconds). During the limited amount of time, the interaction component 702 can focus the viewer's attention to items that are determined to be of interest to the viewer. To draw attention to the items, the interaction component 702 can highlight the items, render the items in a different color, and/or render the items in a different manner than other items, and so on. For example, the interaction component 702 can visually render items determined to be of interest larger than items determined to not be of interest. Alternatively, or additionally, the items not of interest can be visually rendered in a smaller size as compared to how those items would otherwise be output visually. In another example, the interaction component 702 can render the items not of interest in a see-through manner (e.g., background of a screen or display can be visible through the items not of interest).

According to another example, an average focus time on a document can be about two second. However, a particular document is being looked at longer. Therefore, the interaction component 702 can adapts itself to the viewer and can provide more information based on an inference that the particular document is of greater interest based on gaze.

According to some implementations, the interaction component 702 can utilize a smart transcription to interact with the viewer and to adjust an output of the content. For example, the interaction component 702 can determine the rendering environment of the content (e.g., parameters of the computing device utilized to access the content, the external environment of the viewer, and so on). Based on the environment, the interaction component 702 can expose or mask information based on a footprint of the computing device and/or processing capabilities of the computing device. For example, if a desktop computer is utilized, more content can be output as compared to a mobile device that has a small screen size. In another example, if the interaction component 702 determines an external environment of the viewer has an excessive amount of noise (e.g., people talking in the background), a volume can be automatically adjusted higher and/or rendering can be changed from an audio output to a visual output.

FIG. 8 illustrates an example, non-limiting, system 800 for standardizing content across a variety of input sources in accordance with one or more embodiments described herein. Repetitive description of like elements employed in other embodiments described herein is omitted for sake of brevity. The system 800 can comprise one or more of the components and/or functionalities of the system 100, the system 200, the system 300, the system 400, the system 500, the system 600, and/or the system 700, and vice versa.

The system 800 can comprise an equalization component 802 and a matching component 804. The equalization component 802 can normalize one or more portions of aggregated information associated with the target entity as compared to other aggregated information associated with another target entity. For example, the equalization component 802 can evaluate one or more rankings applied by various input sources (e.g., source entities) and standardize the one or more rankings across the sources. For example, the input sources can include different teachers within a single school, teachers in different schools (e.g., a student moved and transferred between schools, students from two or more schools are being considered for entry into a college program and/or an employment position, and so on). By standardizing the rankings, a minimum standard can be maintained while mitigating the amount of discrepancy between teachers and/or schools. Thus, if one teacher or school grades more lenient than another teacher or school, the grades for the students can be evaluated more fairly when being considered for a similar position. It is noted that each school can apply its own mastery standards.

For example, over time data can be cross-correlated and analyzed by the equalization component 802. Based on this cross-correlation and analysis, the equalization component 802 can standardize or normalize the scoring and ranks relative to the students. The normalization can allow a reviewer (e.g., a requesting entity, a college admissions panel, and so on) to more quickly review the candidates in a meaningful and holistic manner In accordance with some implementations, the normalization by the equalization component 802 can facilitate comparison among schools, which can provide further insight into the students that attended a particular school. Further, the equalization component 802 can interface with the correlation component 304 in order to combine information associated with a student that has input provided from two or more schools (e.g., different source entities). These embodiments can also apply to employer rankings associated with the same or similar positions within two or more organizations.

According to some implementations, the equalization component 802 can provide one or more items for review by the different submitting reviewers. Based on the respective feedback, ranking, scores, and other information provided by the one or more reviewers, the equalization component 802 can facilitate the normalization of data across the one or more reviewers. For example, the one or more items submitted for review can be identical. Thus, if a first reviewer gives the item a first score, and a second reviewer gives the item a second score, the equalization component 802 can utilize the disparity between the scores to assist with the normalization of the data.

The matching component 804 can use a rules-based database (or another database) for matching in order for the data to be standardized in a generic manner (e.g., not based on the personal input of one or more teachers). This can also assist with privacy aspects of the one or more embodiments provided herein. For example, based on a rich hyper cube and model, affinity matching can be provided. The matching can facilitate an appropriate fit for the student, teacher, employee, and/or employer, and can be based on different metrics. Further, different preferences of students, as well as preferences of a college, for example, can be taken into consideration during the matching. This can also provide a higher confidence level match according to various implementations.

FIG. 9 illustrates an example, non-limiting, system 900 for aligning goals of a target entity with experiences of the target entity in accordance with one or more embodiments described herein. Repetitive description of like elements employed in other embodiments described herein is omitted for sake of brevity. The system 900 can comprise one or more of the components and/or functionalities of the system 100, the system 200, the system 300, the system 400, the system 500, the system 600, the system 700, and/or the system 800, and vice versa.

The system 900 can comprise a goals component 902 that can obtain goals of one or more students, goals of one or more schools, goals of one or more employees, goals of one or more employers, and so on. The goals can be obtained in real-time as data is being output (e.g., the output data 112) to drive an experiential experience. In an example, the diverse goals can be received through the interface component 208 and/or through another system component. According to some implementations, the respective goal inputs can be facilitated through respective computing devices of the entities. According to an implementation, one or more wireless (or wired) communication links can be established between the system 900 and the one or more computing devices to obtain the goals and/or other information.

For example, the way the student learns (e.g., cognitive perception) can be different than how another student learns. In a classroom setting, the students should be actively learning and enjoying the learning process. Through interaction with the goals component 902, the one or more students can provide respective goals for the class (e.g., specific topics of interest, specific assignments of interest, methods of teaching that are fun for the student, and so on). In some implementations, the students can have a school portfolio they want to enrich and know the class assignments that should be mastered to enrich the school portfolio. Thus, the goals of a first student can be different from goals of a second student.

According to some implementations, the goals component 902 can inventory (or survey) the goals across students in a specific classroom. For example, the one or more students can provide respective wish lists and/or respective ranked orders listing interests for the classroom learning. The goals component 902 can provide a summary of the inventory (or survey) ranking the elements within the respective wish lists and/or the respective ranked orders. For example, the summary can indicate that most students would like to learn x and that half of the students would also like to learn y, and so on. Based on this summary, the teacher can decide to alter the curriculum, or at least portions thereof, to help the students achieve their respective objectives and to make the learning experience more appropriate for the students. In an example, if some students want to pursue creative writing, the teacher can tailor one or more assignments with the option for the students to complete the assignment in essay form.

The goals component 902, therefore, can be utilized as a tool that can allow teachers to further assist the students in achieving their respective goals without the need to expend time going through each portfolio (e.g., a class aggregation view). Thus, the teachers can spend more time focusing on the actual student rather than information about the student.

Accordingly, the goals component 902 can facilitate a learning experience that can be individualized for the students. This is a more holistic approach to allow the students to learn what is important to them and for the teachers to realign the curriculum in a meaningful manner According to some implementations, the curriculum is not changed (e.g., is a sedimentary layer). Instead, the goals can be layered on top of the traditional competency courses (e.g., allowing one or more students to complete an assignment in essay form). Once students think about learning differently, a corresponding change can occur with the teachers, and vice versa.

FIG. 10 illustrates an example, non-limiting, system 1000 that provides for personalization of data input in accordance with one or more embodiments described herein. Repetitive description of like elements employed in other embodiments described herein is omitted for sake of brevity. The system 1000 can comprise one or more of the components and/or functionalities of the system 100, the system 200, the system 300, the system 400, the system 500, the system 600, the system 700, the system 800, and/or the system 900, and vice versa.

The system 1000 can comprise a personalization component 1002 that can obtain input data from an environment that includes multiple sources of input data. For example, the input data can be associated with a classroom setting where multiple students and one or more teachers and/or evaluators are participating in a conversation. The personalization component 1002 can parse the input data received and identify one or more specific individuals and their specific contribution to the conversation.

For example, a microphone array can capture voices and convey the captured voices to the personalization component 1002 (e.g., over a wired or wireless communications link). The personalization component 1002 can evaluate the captured voices for respective voice signatures of the one or more students, the one or more teachers, and/or one or more other people. If a match is found between a captured voice and a voice signature, the personalization component 1002 can associate the content with the contributor. In an implementation, the analysis component 204 can assign metadata to the content, wherein the metadata identifies the contributor.

In another example, one or more video cameras can record interactions within the classroom and convey the captured video to the personalization component 1002 (e.g., over a wired or wireless communications link). Facial recognition or other forms of recognition (e.g., gait recognition, voice signature, and so on) can be utilized by the personalization component 1002 to determine which person has contributed content. If a match is found between at least a portion of the video and a contributor, the personalization component 1002 can associate the portion of the content with the contributor.

According to some implementations, the personalization component 1002 can cultivate resources that support learning. For example, the system 1000 can evaluate the class to determine if students in the class appear to be learning, whether some students appear to be learning faster than other students, which students are interested in a particular topic, and so on. To evaluate the class, the personalization component 1002 can observe the class (e.g., via the one or more video cameras) and evaluate the respective focus of the one or more students and/or the level of attention. For example, if a student is staring into space or looking out the window, it can be inferred that the student is bored or is simply not paying attention. In another example, if a student has been writing or looking down for an extended length of time, while others are focused on something else (e.g., a video presentation, a live presentation, and so on) it can indicate the student is uninterested. In another example, if two students are chatting or passing notes, it can indicate that they are not paying attention. Indications of interest and/or a level of learning, as determined by the personalization component 1002 can include, but are not limited to, the student looking at a presentation, watching the teacher or other person speaking, raising a hand to answer a question, and so on. Information related to the determination can be output to the teacher (e.g., via a computing device) such that the teacher can tailor the method of teaching, or change the technique by which a subject is being presented, in order to facilitate a productive classroom experience. According to some implementations, the notification to the teacher can occur at about the same time as the evaluation is performed by the personalization component 1002. According to other implementations, the notification can be at a different time (e.g., upon a request for the information, during a defined evaluation period, and so on).

FIG. 11 illustrates an example, non-limiting, system 1100 that can provide policing and privacy of aggregation-based qualitative assessment data in accordance with one or more embodiments described herein. Repetitive description of like elements employed in other embodiments described herein is omitted for sake of brevity. The system 1100 can comprise one or more of the components and/or functionalities of the system 100, the system 200, the system 300, the system 400, the system 500, the system 600, the system 700, the system 800, the system 900, and/or the system 1000, and vice versa.

The system 1100 can comprise an observation component 1102 and a privacy component 1104. Policing of the aggregation-based qualitative assessment data can include monitoring public data associated with a target entity (e.g., a student) by the observation component 1102. For example, the system 1100 can consume raw data (e.g., various data that is available but not ready to be published) or other data (e.g., via the data manager component 202). The observation component 1102 can evaluate the raw data, as well as publicly available data, such as data posted to social media sites and/or data that is accessible through one or more computing devices associated with the student (which can include data that is not publicly available). The publicly available data and/or data not publicly available (e.g., input into, or stored on, the student's computing device) can be obtained by the data manager component 202 and/or another system component. The evaluation by the observation component 1102 can be facilitated to identify events and/or behavior by the student that should be stopped, controlled, and/or changed.

For example, if the student is posting potentially embarrassing and/or inappropriate content, the observation component 1102 can evaluate the content for one or more trigger events (e.g., questionable content, dangerous content, inappropriate content, and so on) and the interface component 208 can provide a notification to the student based on an occurrence of at least one trigger event of the one or more triggers as determined by the observation component 1102. The notification can include details as to why the content is questionable and how the content might be perceived by others. This includes perception of current viewers, as well as people that might perceive the content in the future (e.g., potential employers).

The privacy component 1104 can dynamically review the raw data and/or other data and can automatically apply an appropriate security level to the content. The privacy component 1104 can apply the security levels individually or in conjunction with the security component 308.

For example, for the raw data, other people should not have access (e.g., only the target entity should have access to this unfinished data). Therefore, the privacy component 1104 can apply security levels to the content based on a status of the content. According to an implementation, the privacy component 1104 can associate electronic locks with the data. According to other implementations, the privacy component 1104 (and/or the security component 308) can utilize block chains, encryption, authentication, masking, and/or other security parameters in order to provide different access level to different types and/or statuses of data.

FIG. 12 illustrates an example, non-limiting, system 1200 that automates various aspects of the one or more embodiments described herein. Repetitive description of like elements employed in other embodiments described herein is omitted for sake of brevity. The system 1200 can comprise one or more of the components and/or functionalities of the system 100, the system 200, the system 300, the system 400, the system 500, the system 600, the system 700, the system 800, the system 900, the system 1000, and/or the system 1100, and vice versa.

The system 1200 can comprise an artificial intelligence component 1202 and a machine learning and reasoning component 1204. The artificial intelligence component 1202 can assist with building a transcript (e.g., an inventory of the courses taken and associated data related to the courses), another type of document and/or holistic view of the target entity. In some implementations, the artificial intelligence component 1202 can present information in another format (e.g., virtual reality format, audible format, visual format, and so on). For example, the artificial intelligence component 1202 can evaluate the raw data (or other data) to determine what is relevant and what is not relevant. Content that is determined to be relevant can be indexed, tagged, and saved. Content that is determined to not be relevant can be discarded and/or ignored. According to some implementations, the artificial intelligence component 1202 can identify data across devices and applications and selectively pull the data to populate a database.

The system 1200 can employ automated learning to facilitate one or more of the disclosed aspects. For example, the machine learning and reasoning component 1204 can be utilized to automate one or more of the disclosed aspects. The machine learning and reasoning component 1204 can employ automated learning and reasoning procedures (e.g., the use of explicitly and/or implicitly trained statistical classifiers) in connection with performing inference and/or probabilistic determinations and/or statistical-based determinations in accordance with one or more aspects described herein.

For example, the machine learning and reasoning component 1204 can employ principles of probabilistic and decision theoretic inference. Additionally, or alternatively, the machine learning and reasoning component 1204 can rely on predictive models constructed using machine learning and/or automated learning procedures. Logic-centric inference can also be employed separately or in conjunction with probabilistic methods.

In accordance with an aspect, the machine learning and reasoning component 1204 can infer intention of a request to capture data, categorization of the data, and/or retrieval of the data by obtaining knowledge about the possible actions and knowledge about what the entity is trying to accomplish based on applications or programs being implemented by the entity, the application/program entity, the user context, or combinations thereof. Based on this knowledge, the machine learning and reasoning component 1204 can make an inference based on which actions to implement, how to index the data, which data should be related and the closeness of the data, or combinations thereof.

According to some implementations, the machine learning and reasoning component 1204 can learn data associated with students and can build models associated with the data. There can be a tremendous amount of raw data that should be analyzed. The machine learning and reasoning component 1204 can consume the data and create a robust model of the student that can be dynamically modified as new information is received. Further, as additional data is received, the machine learning and reasoning component 1204 can adapt and refine the models. In an example, the machine learning and reasoning component 1204 can take multiple file types and can convert the files into a constant format (audio, video, text). Over time, the machine learning and reasoning component 1204 can refine previous (historical) data.

In accordance with some implementations, the machine learning and reasoning component 1204 can infer intention of a request to capture data, categorization of data, and/or retrieval of data by obtaining knowledge about the possible actions and knowledge about what the entity is trying to accomplish based on applications or programs being implemented by the entity, the application/program entity, the user context, or combinations thereof. Based on this knowledge, the machine learning and reasoning component 1204 can make an inference based on which actions to implement, how to index the data, which data should be related and the closeness of the data, or combinations thereof.

As used herein, the term “inference” refers generally to the process of reasoning about or inferring states of the system, a component, a module, the environment, and/or mobile devices from a set of observations as captured through events, reports, data and/or through other forms of communication. Inference can be employed to identify a specific context or action, or can generate a probability distribution over states, for example. The inference can be probabilistic. For example, computation of a probability distribution over states of interest based on a consideration of data and/or events. The inference can also refer to techniques employed for composing higher-level events from a set of events and/or data. Such inference can result in the construction of new events and/or actions from a set of observed events and/or stored event data, whether or not the events are correlated in close temporal proximity, and whether the events and/or data come from one or several events and/or data sources. Various classification schemes and/or systems (e.g., support vector machines, neural networks, logic-centric production systems, Bayesian belief networks, fuzzy logic, data fusion engines, and so on) can be employed in connection with performing automatic and/or inferred action in connection with the disclosed aspects.

If the machine learning and reasoning component 1204 has uncertainty related to the intent or request, the machine learning and reasoning component can automatically engage in a short (or long) dialogue or interaction with the entity (e.g., “What do you mean?”). In accordance with some aspects, the machine learning and reasoning component 1204 can engage in the dialogue with the entity through another system component (e.g., the interface component 208). Computations of the value of information can be employed to drive the asking of questions. Alternatively, or additionally, a cognitive agent component (not shown) and/or the machine learning and reasoning component 1204 can anticipate an entity action (e.g., “should this data be gathered?”) and continually, periodically, or based on another interval, update a hypothesis as more user actions are gathered. The cognitive agent component can accumulate data or perform other actions that are a result of anticipation of the user's future actions.

A classifier is a function that maps an input attribute vector, x=(x1, x2, x3, x4, xn), to a confidence that the input belongs to a class. In other words, f(x)=confidence(class). Such classification can employ a probabilistic and/or statistical-based analysis (e.g., factoring into the analysis utilities and costs) to prognose or infer an action that should be employed to determine what a user desires to be automatically performed.

A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that can be similar, but not necessarily identical to training data. Other directed and undirected model classification approaches (e.g., naïve Bayes, Bayesian networks, decision trees, neural networks, fuzzy logic models, and probabilistic classification models) providing different patterns of independence can be employed. Classification as used herein, can be inclusive of statistical regression that is utilized to develop models of priority.

One or more aspects can employ classifiers that are explicitly trained (e.g., through a generic training data) as well as classifiers that are implicitly trained (e.g., by observing user behavior, by receiving extrinsic information, and so on). For example, SVM's can be configured through a learning or training phase within a classifier constructor and feature selection module. Thus, a classifier(s) can be used to automatically learn and perform a number of functions, including but not limited to determining according to a criteria (which can be predetermined) when to implement an action, which action to implement, what requests to group together, relationships between requests, and so forth. The criteria can include, but is not limited to, similar requests, historical information, and so forth.

Additionally, or alternatively, an implementation scheme (e.g., a rule, a policy, and so on) can be applied to control and/or regulate requests and resulting actions, inclusion of a group of users to carry out actions associated with the requests, privileges, and so forth. In some implementations, based upon a predefined criterion, the rules-based implementation can automatically and/or dynamically interpret requests. In response thereto, the rule-based implementation can automatically interpret and carry out functions associated with the request by employing a predefined and/or programmed rule(s) based upon any desired criteria.

FIG. 13 illustrates a flow diagram of an example, non-limiting, computer-implemented method 1300 that facilitates automatic transformation of a multitude of disparate types of input data into a holistic, self-contained, reference database format that can be rendered at varying levels of granularity in accordance with one or more embodiments described herein. The computer-implemented method 1300 (as well as other computer-implemented methods discussed herein) can be implemented by a system comprising a processor and/or a mobile device comprising a processor. Alternatively, or additionally, a machine-readable storage medium can comprise executable instructions that, when executed by a processor, facilitate performance of operations for the computer-implemented method 1300 (as well as other computer-implemented methods discussed herein). Repetitive description of like elements employed in other embodiments described herein is omitted for sake of brevity.

First data and second data can be received from a source entity, at 1302 of the computer-implemented method 1300 (e.g., via the data manager component 202). The first data can comprise a first set of content and the second data can comprise a second set of content. The first set of content and the second set of content can contribute to a holistic life view of a target entity. According to some implementations, the first set of content can be in a first format (e.g., a document comprising handwritten notes) and the second set of content can be in a second format (e.g., a video).

At 1304 of the computer-implemented method 1300, a first metadata can be added to the first data based on the first set of content and a second metadata can be added to the second data based on the second set of content (e.g., via the analysis component 204). The first metadata and the second metadata can facilitate ease of retrieval of the first data and the second data from a reference database. Further, the first metadata and the second metadata can indicate the first set of content and the second set of content are related to the target entity.

Aggregated content can be output at varying viewing granularity levels, at 1306 of the computer-implemented method 1300, based on a first request for the holistic life view of the target entity (e.g., via the output component 310). The aggregated content can comprise the first set of content, the second set of content, and historical information determined to be associated with the target entity.

It is noted that although various embodiments discussed herein relate to receiving new content (e.g., input data) and outputting the new content with historical content, the disclosed aspects are not limited to this implementation. Instead, according to some implementations, only historical data is output (e.g., there has been no new content added). In other implementations, the new content (e.g., input data) can be considered historical content upon or after storage in the database.

FIG. 14 illustrates a flow diagram of an example, non-limiting, computer-implemented method 1400 that facilitates rending a holistic life view of a target entity at varying levels of granularity in accordance with one or more embodiments described herein. Repetitive description of like elements employed in other embodiments described herein is omitted for sake of brevity.

At 1402 of the computer-implemented method 1400, a request to receive a holistic life view of a target entity can be received from a requesting entity (e.g., via the interface component 208). For example, as discussed herein, holistic data capture and analysis is provided. Information related to a target entity (or more than one target entity) can be gathered over time, including over a period of years, and retained in a database in an indexed format that facilitates retrieval of the information. For a student, the database can include every homework assignment prepared by the student, every test taken, every report written, and so on. The documents can be electronically scanned for storage in the database and/or can be captured through other means (e.g., through one or more sensors, based on direct input, and so on). This data can be cumulative (e.g., added to daily, weekly, monthly, over the years, and so on). In an example, each source entity (e.g., one or more teachers) can provide a qualitative assessment of the target entity (e.g., the student) regarding mastery of one or more subjects, the student's character, the student's attitude, and other information related to the student. This data can be captured over the student's (or another target entity's) lifetime (e.g., during employment and/or periods of nonemployment, during vacations, after retirement, data related to health, data related to sports, and so on).

Aggregated content, associated with the target entity can be output, at 1404 of the computer-implemented method 1400, in response to the request (e.g., via the output component 310). The aggregated content can be output at varying viewing granularity levels. For example, the varying viewing granularity levels can comprise a first granularity level and a second granularity level that is greater than (e.g., at a higher granularity level than) the first granularity level. Further, the varying viewing granularity levels can comprise at least a third granularity level that is greater than (e.g., at a higher granularity level than) the second granularity level.

The computer-implemented method 1400 can comprise, at 1406, outputting the first set of aggregated content associated with the target entity at the first granularity level (e.g., via the zooming component 406). The first granularity level can be a high-level overview of the holistic life view of the target entity, according to an implementation.

Further, at 1408, the computer-implemented method 1400 can comprise altering the varying viewing granularity levels from the first granularity level to the second granularity level based on a request for additional details related to a first subset of the aggregated content (e.g., via the zooming component 406). Based on a request for an in-depth review of a first defined portion of the first set of the aggregated content, the varying viewing granularity levels can be adjusted from the second granularity level to the third granularity level, at 1410 of the computer-implemented method 1400 (e.g., via the zooming component 406).

Upon or after the requesting entity is finished reviewing the data at the second granularity level, at the third granularity level, or at subsequent granularity levels, the output of the aggregated data can return to the high-level overview (e.g., the first granularity level). According to an implementation, if the output is at the third granularity level, the view can be changed to the second granularity level, and, thereafter to the first granularity level. The determination as the granularity level that should be output can be based on one or more indications received from the requesting entity, for example.

FIG. 15 illustrates a flow diagram of an example, non-limiting, computer-implemented method 1500 that facilitates rending a holistic life view of a target based on one or more defined rendering criteria in accordance with one or more embodiments described herein. Repetitive description of like elements employed in other embodiments described herein is omitted for sake of brevity.

At 1502 of the computer-implemented method 1500, a request to obtain a holistic life view of a target entity can be received from a requesting entity (e.g., via the interface component 208). Upon or after receipt of the request, a determination can be made, at 1504 of the computer-implemented method 1500, whether access to at least a portion of the holistic life view of the target entity is restricted (e.g., via the security component 308). The restriction can be determined based on one or more rendering criteria. For example, the one or more rendering criteria can include, but are not limited to, credentials of the requesting entity, a security level associated with the content, a completion level of the content, and preferences of the target entity.

If the determination is that at least a portion of combined data that represents the holistic life view of the target entity should be restricted (“YES”), at 1506 of the computer-implemented method 1500, the one or more restricted portions of combined data can be masked or removed from an output of the combined information (e.g., via the privacy component 1104). At 1508 of the computer-implemented method 1500, the remaining portions of the combined data, other than the masked portion(s), can be output at varying viewing granularity levels based on the request for the holistic life view of the target entity (e.g., via the interface component 208 and/or the zooming component 406).

If the determination is that at least a portion of combined data that represents the holistic life view of the target entity should not be restricted (“NO”), at 1510 of the computer-implemented method 1500, combined data can be output, without modification, at varying viewing granularity levels based on the request for the holistic life view of the target entity (e.g., via the output component 310. The combined data can include received input data (including historical data) that has been tagged with metadata that indicated the received input data is related to the target entity or another parameter based on a search request from the requesting entity.

FIG. 16 illustrates a flow diagram of an example, non-limiting, computer-implemented method 1600 that facilitates outputting information related to a target entity in a virtual reality environment in accordance with one or more embodiments described herein. Repetitive description of like elements employed in other embodiments described herein is omitted for sake of brevity.

At 1602 of the computer-implemented method 1600, an overall view of information related to a target entity can be output to a requesting entity based on a query received from the requesting entity for the overall view (e.g., via the output component 310). Prior to outputting the overall view, viewing credentials associated with the target entity, the requesting entity, and the information can be determined and selectively applied.

According to an implementation, at 1604 of the computer-implemented method 1600, at least portions of the overall view can be output as a cubic view (e.g., via the virtual reality component 502). For example, the cubic view can represent one or more rooms of a structure. The overall view can be divided into various categories (e.g., year in school, age, type of class, employment, vacations, life events, or other criteria). According to some implementations, at least a set of the various categories can be defined by the target entity. Additionally, or alternatively, the various categories, can be automatically determined (e.g., based on an analysis of the data received).

Further, at 1606 of the computer-implemented method 1600, a format of at least one object associated with the output data can be altered. For example, documents can be rendered such that they appear larger and/or can appear as if they are suspended on walls such that the requesting entity can “walk up” to the document in order to view the document. In another example, a picture of an object can be rendered in a 3-D format and the requesting entity can (virtually) walk around the object. According to some implementations, in order to render the information in a virtual reality environment, one or more wearable devices can be utilized. For example, to be immersed in the virtual reality environment, the requesting entity can wear virtual reality head gear (e.g., a helmet, a pair of glasses, goggles, and so forth) that has been configured to enable the virtual reality viewing of the data.

FIG. 17 illustrates a flow diagram of an example, non-limiting, computer-implemented method 1700 that facilitates providing one or more notifications based on detection of a trigger event in accordance with one or more embodiments described herein. Repetitive description of like elements employed in other embodiments described herein is omitted for sake of brevity.

The computer-implemented method 1700, at 1702, can monitor public data associated with one or more target entities (e.g., via the observation component 1102). For example, the monitoring can be based on establishing a wireless (or wired) connection with respective one or more computing devices utilized by the one or more target entities. Based on the connection, input into the respective one or more computing devices can be automatically captured (e.g., communicated). In another example, the public data can be monitored based on input uploaded to one or more social media platforms. In a further example, information exchanged with others (e.g., via emails, text messages, or other formats) can be monitored. In yet another example, photos and/or videos taken by, or about the one or more target entities can be monitored.

At 1704 of the computer-implemented method 1700, the public data can be evaluated for one or more triggering events (e.g., via the observation component 1102). For example, the one or more triggering events can be behavior that is not socially acceptable, or that should not be socially acceptable. For example, a triggering event can be behavior that is illegal, immoral, and/or otherwise deemed to be in bad taste. In another example, a triggering event can be questionable content, dangerous content, inappropriate content, and so on.

If the evaluation reveals that a triggering event of the one or more triggering events has occurred, a notification can be output to the target entity (e.g., via the interface component 208). In an example, the notification can include details as to why the content is questionable and how the content might be perceived by others. This can include perception of current viewers, as well as people that could perceive the content in the future (e.g., potential employers).

FIG. 18 illustrates a flow diagram of an example, non-limiting, computer-implemented method 1800 that facilitates normalization between first content associated with a first entity and second content associated with a second entity in accordance with one or more embodiments described herein. Repetitive description of like elements employed in other embodiments described herein is omitted for sake of brevity.

At 1802 of the computer-implemented method 1800, respective items for review can be requested from two or more reviewing entities based on a determined disparity between the two or more reviewing entities (e.g., via the output component 210 or the equalization component 802). For example, the two or more reviewing entities can be teachers, schools, employers, and so on. In a specific example, a first teacher could evaluate a student more harshly than a second teacher. In another example, a first school can have a higher standard for students than a second school and, therefore, the first school judges the students more critically. The respective items for review can be an item that can be evaluated by the two or more reviewing entities. Examples of respective items can include, but are not limited to, essays, book reports, artistic creations, a video recording of a speech, and so on.

Respective feedback can be received from the two or more reviewing entities, at 1804 of the computer-implemented method 1800 (e.g., via the data manager component 202 or the interface component 208). For example, the reviewing entities can be provided guidelines for the review and/or can be given a deadline to provide the feedback. Although discussed with respect to feedback, other data, such as ranking, scores, and other information can be provided by the two or more reviewing entities.

At 1806 of the computer-implemented method 1800, evaluations provided by the two or more entities can be normalized based on the feedback received (e.g., via the equalization component 802). For example, the one or more items submitted for review can be identical. Thus, if a first reviewer gives the item a first score, and a second reviewer gives the item a second score the disparity between the scores can be utilized to assist with the normalization of the data.

According to some implementations, a rules-based database (or another database) for matching can be utilized in order for the data to be standardized in a generic manner (e.g., not based on the personal input of one or more teachers). This can also assist with privacy aspects of the one or more embodiments provided herein.

FIG. 19 illustrates a flow diagram of an example, non-limiting, computer-implemented method 1900 that facilitates providing respective holistic life views for one or more target entities in accordance with one or more embodiments described herein. Repetitive description of like elements employed in other embodiments described herein is omitted for sake of brevity.

At 1902 of the computer-implemented method 1900, a first set of content related to a first target entity and a second set of content related to a second target entity can be received (e.g., via the data manager component 202). The first set of content and the second set of content can be received automatically (e.g., via one or more cameras, one or more sensors, one or more microphones, and so on) and/or can be received from one or more other source entities.

The first set of content can be augmented with a first metadata and the second set of content can be augmented with a second metadata, at 1904 of the computer-implemented method 1900 (e.g., via the analysis component 204). The first metadata can associate the first set of content with the first target entity and the second metadata can associate the second set of content with the second target entity.

At 1906 of the computer-implemented method 1900, the first set of content, the first metadata, the second set of content, and the second metadata can be stored in a reference database (e.g., via the database 206). According to some implementations, the reference database can comprise a first set of historical content associated with the first target entity and a second set of historical content associated with the second target entity. Further, the computer-implemented method 1900 can comprise, at 1908, outputting, at varying viewing granularity levels, at least one of a first set of aggregated content and a second set of aggregated content (e.g., via the output component 310).

The first set of aggregated content can be output based on a first request for a first holistic life view of the first target entity. Further, the first set of aggregated content can comprise the first set of content, the first metadata, and the first set of historical content.

The second set of aggregated content can be output based on a second request for a second holistic life view of the second target entity. Further, the second set of aggregated content can comprise the second set of content, the second metadata, and the second set of historical content.

As mentioned above, the use of computing devices for capturing life experiences is commonplace. For many people, virtually all activities are performed through interaction with a computing device. For example, rather than meeting a person face-to-face or placing a telephone call, text messages and other electronic communications are more commonly used. Further, during an activity, photographs, audio recordings, and/or videos are taken not only to memorialize the event, but to almost instantaneously share the event with others. In addition, documents that a few years ago were only available in physical form are now provided in electronic format. Over time, to review these captured moments, an individual either has to access the computing device on which the electronic information is stored (if still available) and/or attempt to access the electronic information through a website or server that is managed by someone else.

In accordance with one or more aspects and corresponding disclosure thereof, various aspects are described in connection with an internet-based or mobile-based aggregation-based holistic data capture and analysis and/or an internet-based or mobile-based aggregation-based qualitative assessment. Systems and methods for highly granular data capture and analysis of electronic records associated with one or more individuals are provided. Conventional data capture systems, assessment systems, and corresponding methods typically do not provide a meaningful data capture and provide very little, if any analysis of the electronic data as it relates to an individual. Further, once the electronic data is stored on a third-party hosting site, the data is no longer within the control of the individual. The subject innovation(s) provide for archiving meaningful information about an individual that can be selectively accessed to gain a holistic view of how that individual has progressed through school, professional experience, and other areas of the individual's life that provide meaningful insights into the progression of the individual over a period of time, which could be a significant period of time.

In a school example, individual assignments, tasks, accomplishments, failures, awards, reprimands, significant moments, interactions with others, hobbies, and so on can be documented (e.g., by the individual, teachers, evaluators, employers. and so on). The electronic information captured can include qualitative assessment with respect to mastery of topics, character attributes, attitude, reliability, timeliness, professionalism, development, weaknesses, areas for improvement, goals, and so on. This electronic information can be tagged, indexed, aggregated, and assigned various levels of confidentiality to develop a rich database of information that can be accessed and utilized with numerous layers or levels of granularity or scope in order to provide a holistic view of the individual. Searching, filtering, indexing, and cataloging tools can be employed to glean information about the individual from one of many numerous points of view. Machine learning and artificial intelligence can be employed to learn the vast amounts of data associated with each individual and can further be employed with rapid qualitative assessment as well as ranking with respect to other individuals.

In a scholastic setting (as well as in other settings, such as a workplace) performance evaluations generally take the form of a scale that is used to rank a performance of a person. For example, grading in educational settings relates to the process of applying standardized measurements of varying levels of achievement in a particular course. For example, grades can be assigned based on a letter scale (e.g., A through F) or a percentage of a total number of questions answered correctly (e.g., 0% through 100%), or as a number of questions answered correctly out of a total amount of question asked (e.g., 3 out of 10, 49 out of 50, 76 out of 80, and so on). In an employment setting, a performance review might rank an employee's performance on a scale of 1 through 5, for example. Insights as to what an individual has achieved, the competency of the individual, and other important data about the individual is not available by merely reviewing the rankings assigned.

To further explain various aspects, a specific example related to a classroom experience will now be discussed. However, the disclosed aspects are not limited to a classroom experience and other data related to other life experiences can be obtained and processed as discussed herein.

An implementation relates to a college preparation model for high schools, which can comprise an alternative model of assessment, crediting, and transcript generation. For example, the student, through the collection of input data, can demonstrate a mastery of skills, knowledge, and habits of mind by presenting evidence that is then assessed against an institutionally specific standard of mastery (rubric). Thus, the one or more aspects provided herein can be substantively different from the traditional model of assessment that is typically organized around content oriented courses, Carnegie units for credit and A to F letter grades.

For example, one or more aspects can be organized around performance areas (rather than academic departments), and mastery standards and micro-credits (rather than letter grades). Each micro-credit (e.g., badge) applied to a transcript can signify complete mastery of a specific skill, knowledge block, or habit of mind as defined by the crediting high school.

The schools can be supported by a technology platform that allows the complete record of a student's credits, institutional standards, and performance evidence to be gathered in a holistic, self-contained, reference database, which can be submitted to college admission offices for evaluation. The holistic, self-contained, reference database can allow college admission officers to dive deep within a transcript to see the specific standards of the sending high school and actual evidence of student work and mastery, thus giving depth and transparency to the student's work record. Thus, the various aspects can be utilized to change the relationship between preparation for college and college admissions for the betterment of students.

In an example, challenges associated with the industrial model of education can include single credit, discipline based courses; short block teaching; de-contextualized learning; letter grades; and/or time based (snapshot) assessment. These challenges can lead to a graded, content oriented, single course transcript.

According to a first example, for the graded transcripts, which are estimated to be utilized in about ninety-eight percent of schools, the focus can be on single discipline, content oriented courses. The grading for the graded transcripts can be letter grades. Further, the graded transcripts rely on short block teaching and can be time based (e.g., snapshot in time grading). According to a second example related to non-graded transcripts, which are estimated to be utilized in about two percent of schools, the focus is on a single discipline course, with no grades, and can comprise a long form narrative (e.g., used in place of the letter grades).

To alleviate these and other challenges the disclosed aspects can provide a new model that comprises interdisciplinary courses; multi-credit courses; long block teaching applied learning; applied learning (e.g., real world problem solving); mastery based assessment; and or micro credits (instead of grades), which leads to a “mastery transcript.”

In an example, the one or more aspects provided herein (e.g., the mastery transcript) can comprise interdisciplinary courses; multi-credit, skills based courses; mastery based assessment (e.g., assessed when ready); long block teaching; and mastery “micro.” credits.

The competency based transcript model, namely a transcript/credit level model, a standards/rubrics level model, and an evidence/artifacts/“best work” level model. These models will be discussed below with respects to FIGS. 21-24.

FIG. 20 illustrates an example, non-limiting, representation of various levels 2000 related to information and privacy in accordance with one or more embodiments described herein. Repetitive description of like elements employed in other embodiments described herein is omitted for sake of brevity.

A raw data level 2002 can include all information that can be gathered, either directly or indirectly related to one or more target entities. Due to the amount of data available in the raw data level 2002 one or more subsets of raw data within the raw data level 2002 can be obtained in accordance with the various aspects discussed herein. Since the raw data level 2002 can include all information that has been collected, the raw data level 2002 can include information not intended to be included in the reference database (e.g., the database 206) associated with one or more target entities.

A mastery transcript component 2004 can be configured to gather (directly or indirectly through one or more source entities) the various information included in the raw data level 2002. The mastery transcript component 2004 can determine whether or not the information should be retained. In some cases, the raw data captured should be discarded based on various criteria including preferences of a target entity associated with the raw data. The mastery transcript component 2004 can include (or can be included in) one or more of the systems discussed herein.

A student database level 2006 can be a level that should be only available for consumption by the student (e.g., the target entity). The student database level 2006 can include work that has not been submitted for a grade (e.g., work in process). According to some implementations, the data in the student database level 2006 can include information that is in process and not ready for consumption because the information is in its basic form.

Upon or after the student submits work for grading, has presented the work (orally, visually, or through other means), or has otherwise been communicated to others, the data can move from the student database level 2006 to a presentation level 2008. When data is in the presentation level 2008, the student and one or more teachers, advisors, or other requesting entities within the school (that have the appropriate access privileges) can access the data (e.g., through respective communication devices). Further, data in the presentation level 2008 can be modified, additional data can be included, data can be deleted, and so on. Thus, the data within the presentation level 2008 is not static, but can be changed as desired.

Upon or after credit for the work has been issued, one or more elements associated with the data can be move from the presentation level 2008 to the credit issued level 2010. In some implementations, the school (and entities within the school) might be the only requesting entities that have access to the credit issued level 2010. However, the disclosed aspects are not limited to this implementation and other requesting entities, outside the school, could have access to the data contained in the credit issued level 2010 (e.g., parent(s), guardian(s), law enforcement, and so on). According to an implementation, the credit issued level 2010 can contain grades, teacher notes, and other information collected by school personnel (e.g., via respective communication devices).

According to an implementation, a teacher assessment can be substantially the same between a first set of students that prefer a letter grade and a second set of students that prefer a mastery transcript. For example, there can be tests, papers, quizzes, and other classroom and/or homework that should be completed by the student. For the mastery transcript, there is no letter grade given. Instead, there can be tags (e.g., keywords) associated with the teacher's notes based on the work presented by the student. The actual work can be retained within the presentation level 2008 or in both the presentation level 2008 and the credit issued level 2010.

As the student progresses through school (e.g., from preschool through high school and beyond), data related to the student can be included in a transcript accessible from the process level 2012. The transcript in the process level 2012 does not include the final transcript and is not static. Therefore, the data or transcript in the transcript in process level 2012 can be modified (e.g., data can be changed, added, deleted, and so on). Upon or after the transcript is finalized, the data can be retained in a school transcript level 2014.

A college review level 2016, a graduate school level 2018, and/or an employer level 2020 can be utilized to access the school transcript level 2014. According to some implementations, data retained below the school transcript level 2014 might not be accessible at the college review level 2016, the graduate school level 2018, and/or the employer level 2020. However, privacy considerations can be configured based on what the owner of the data (e.g., the target entity) would like to release. For example, the target entity can configure the access available per level and/or based on individual pieces of content within each level (e.g., via the privacy component 1104).

According to some aspects, artifacts associated with lower levels can be selectively submitted for consumption by requesting entities associated with the higher levels and/or other levels (e.g., a social network level). For example, a requesting entity associated with an employer can access the school transcript level 2014, based on authorization from the target entity. Further, data can be added to the holistic view of the target entity during the upper levels (college review level 2016, graduate school level 2018, and/or employer level 2020), as discussed herein.

It is noted that the level representation of FIG. 20 is for example purposes only and the disclosed aspects are not limited to the levels illustrated and described. In some implementations, school levels might not be available if data gathering began after high school or college (e.g., started at an employment level).

Although the following tools are discussed with respect to a student, the disclosed aspects are not limited to an educational setting and the following tools and related descriptions are provided for purposes of explaining the one or more aspects herein. Further, the tools can be provided, for example, by the modification component 408.

In one example, a tool can be a life and college badge maintenance tool that can allow a student to continue to add college work to their portfolio and produce an electronic resume of their best work. The life and college badge maintenance tool can also be utilized beyond college and can extend the accumulation, retrieval, and modification of data through employment, retirement, and other life events.

Another example tool can be a college student success tracking tool that can be utilized by an authorized entity (based on permission from the target entity). The college student success tracking tool can allow colleges (e.g., personnel in a college admission office) to estimate the student's success in college based on their original mastery transcript credits. For example, various aspects of the student's grade school education, other than traditional letter grades, could be more beneficial to determining potential success in college and can be utilized by the admissions office. Thus, the admissions office can have a holistic view of the student as an individual, not simply as a traditional letter grade and based on teacher recommendations. Further, the college student success tracking tool can facilitate a transcript to success correlation, which can indicate how the student's grades and professor feedback correlate to their actual college grades, and so on.

Further, a college admission office transcript quality auditing tool can be provided. The college admission office transcript quality auditing tool can be utilized at a sending school (e.g. high school) validation level and can allow colleges to verify the quality of the student work product from any school (e.g., any high school).

Also provided can be a college admission office mastery transcript reading/evaluating tool. This tool can include a mechanism for ‘spot’ checking artifacts (e.g., content) from the portfolio (e.g., the output data 112) of a target entity. The college admission office mastery transcript reading/evaluating tool can be utilized at a college admission evaluation level and/or a final transcript level (e.g., can produce the final high school transcript).

A final “official” transcript production tool can provide a mechanism to generate the final transcript to be sent to colleges and for graduation. This tool can comprise a print capability and/or an online version of a holistic, self-contained, reference database (e.g., the database 206).

Also provided can be an “in process” transcript production tool. For example, upon or after credit for coursework is issued, the coursework can immediately go onto the student “in process” unofficial transcript for mastery credit. Students, parents, and advisors can monitor the transcript at any time according to one or more aspects discussed herein. At a credit issuance level, the “in process” transcript production tool can provide teacher(s) the ability to review the submission for consideration by the student for crediting. Thus, the teacher can either issue credit or reject with comments back to the student and/or the advisor.

A teacher/panel portfolio review tool can provide a mechanism to easily review the portfolio artifacts submitted for review, and comment on the portfolio artifacts in relationship to rubric criteria. At the portfolio level, a student, with help from an advisor, can choose the “best work and feedback” from the database and can elevate the selected work and feedback to the portfolio layer for credit review. This selected work and feedback can be made public.

A curation tool can provide a mechanism to search database levels to elevate “best work” to portfolio level. At a database level, all learning artifacts for the student (e.g., papers, tests, teacher feedback, letters of recommendation, videos, etc.) can be indicated as not for public consumption. Also provided can be a teacher/student submission tool. This tool can allow the submission of data by the teacher and/or the student.

School set up tools can be established prior to allowing students and faculty to utilize the one or more aspects discussed herein. School set up tools can include a performance area creator tool that can facilitate transcript formatting. Another school set up tool can be credit standards (e.g., rubric) creator tool. Further, a credit badges creator tool can be provided to facilitate defining credits. Optionally, the credit badges creator tool can facilitate inclusion of a level of difficulty, rarity, or rigor. Another school set up tool can be Leaning Management Systems (LMS) tools, which can be APIs. The LMS tools (or APIs) can allow artifacts in existing learning management systems (to shuttle files into the student database layer (e.g., can export data from one system and import the data into another system).

FIG. 21 illustrates an example, non-limiting, mastery transcript 2100 in accordance with one or more embodiments described herein. Repetitive description of like elements employed in other embodiments described herein is omitted for sake of brevity.

The mastery transcript 2100 can represent the transcript/credit level model. As illustrated, the mastery transcript 2100 can be in the form of a document that can be perceived on a communications device. It is noted that although particular placement of various items within the mastery transcript 2100 are illustrated and described, the disclosed aspects are not limited to these placements. Instead, the various information can be at different locations within the mastery transcript 2100. Further, different and/or additional information can be utilized with the mastery transcript 2100 than the information shown and described.

The mastery transcript 2100 can provide student information 2102 (e.g., student name and related information, such as address, age, grade level, status (e.g., current student, previous student, future student), and so on). Also included can be school information 2104 (e.g., name and address) and a current date 2106 (e.g., the date on which the report was ran). Also included can be one or more categories of mastery (e.g., categories of competency areas). For example, as illustrated categories can include, but are not limited to, communications 2108, decision making and problem solving 2110, research and analysis 2112, leadership and teamwork 2114, and global and cultural competency 2116.

Further, as illustrated in the mastery transcript 2100, there can be an indication of graduation requirements 2118, as well as college and graduate level mastery 2120 (if applicable). The circles represent micro-credits and/or badges (simply referred to as micro-credit). As the student completes a defined credit, information (e.g., input data 110) can be categorized into the respective micro-credit. For example, the unshaded circles indicate that the work applied to the particular micro-credit has not been completed. However, the shaded circles indicate that work has been completed and applied to the specific micro-credit.

By way of example, and not limitation, four graduation requirements, out of eight for the communications 2108 competency area have been completed. Further, for the research and analysis 2112 competency area, four micro-credits (out of eight) have been completed. As indicated, the micro-credits can be performed “out of order” (e.g., there is no requirement that the competency has to be performed in any particular order).

Further, the micro-credits under the college and graduate level mastery 2120, indicated with the dashed circles, can also be completed during (or after) the high-school level course work. As the specific competency areas are completed, the circles can be shaded or otherwise marked to indicate that there is information available relative to those particular micro-credits.

FIG. 22 illustrates an alternative example, non-limiting, mastery transcript 2200 in accordance with one or more embodiments described herein. Repetitive description of like elements employed in other embodiments described herein is omitted for sake of brevity.

As illustrated in FIG. 22, a different format of a mastery transcript 2200 can be utilized in accordance with one or more aspects. In an example, the hexagons can be related to different public speaking opportunities. Further, shaded boxes can indicate the task has been completed and unshaded boxes can indicate that a public speaking opportunity still needs to be completed. However, the disclosed aspects are not limited to this implementation and other types of distinguishing between finished and unfinished tasks can be utilized.

FIG. 23 illustrates an example, non-limiting, mastery rubric 2300 that provides detailed information for one micro-credit 2302 of the mastery transcript 2100 of FIG. 21 in accordance with one or more embodiments described herein. Repetitive description of like elements employed in other embodiments described herein is omitted for sake of brevity.

The mastery rubric 2300 can represent a standards/rubrics level model. As indicated, the mastery rubric 2300 provides more detailed information related to the selected micro-credit 2302. Other mastery rubrics can be output based on selections of other micro-credits. Accordingly, the requesting entity can obtain more detailed information related to a micro-credit of interest (e.g., a first granularity level).

FIG. 24 illustrates example, non-limiting, portfolio evidence 2400 that provides further detailed information related to the mastery rubric 2300 of FIG. 23 in accordance with one or more embodiments described herein. Repetitive description of like elements employed in other embodiments described herein is omitted for sake of brevity.

The portfolio evidence 2400 can be evidence/artifacts/“best work” level model. According to an example, the target entity can select the evidence that should be included at this level (e.g., via the interface component 208). The portfolio evidence 2400 can include a number of additional details related to a component 2402 of the mastery rubric 2300 (e.g., a third granularity level). The illustrated portfolio evidence 2400 includes three different evidences, namely, a first evidence 2404₁, a second evidence 2404₂, and a third evidence 2404₃. The respective cells in the mastery rubric 2300 can be selected to provide the respective portfolio evidence.

Thus, as illustrated in FIGS. 21 through 24, the mastery transcript 2100 can be supported by the mastery rubric 2300, which can be supported by the portfolio evidence 2400. Further, the information can be rendered based on a request for additional detailed information (e.g., the varying viewing granularity levels) as discussed herein.

According to a specific, non-limiting, example, desired competencies (e.g., competency areas) can include analytical and creative thinking and problem-solving, complex communication (oral and written), and leadership and teamwork. Additionally, or alternatively, other desired competencies can include digital and quantitative literacy, global perspective, adaptability, initiative and risk-taking, habits of mind; and/or integrity and ethical decision-making

By way of example and not limitation, analytical and creative thinking and problem-solving competencies can include various micro-credits/badges such as the ability to: identify, manage and address complex problems; detect bias, and distinguish between reliable and unsound information; control information overload; formulate meaningful questions; analyze and create ideas and knowledge; use trial and error, devise and test solutions to problems; imagine alternatives; develop cross-disciplinary knowledge and perspective; engage in sustained reasoning; synthesize and adapt; solve new problems that do not have rule-based solutions; and/or use knowledge and creativity to solve complex “real-world” problems.

Examples of micro-credits/badges for leadership and teamwork competencies can include, but are not limited to: initiate new ideas; lead through influence; build trust, resolve conflicts, and provide support for others; facilitate group discussions, forge consensus, and negotiate outcomes; teach, coach, and counsel others; enlist help; collaborate tasks, manage groups, and delegate responsibilities; implement decisions and meet goals; and/or share the credit.

Non-limiting examples of various micro-credits/badges for digital and quantitative literacy competencies can include, but are not limited to: understand, use and apply digital technologies; create digital knowledge and media; use multimedia resources to communicate ideas effectively in a variety of forms; master and use higher-level mathematics; and/or understand traditional and emerging topics in math, science, and technology, environmental sciences, robotics, fractals, cellular automata, nanotechnology, and biotechnology.

Further, non-limiting examples of global perspective competencies can include various micro-credits/badges such as, but not limited to: develop open-mindedness, particularly regarding the values, traditions of others; understand non-western history, politics, religion, and culture; develop facility with one or more international languages; use technology to connect with people and events globally; develop social and intellectual skills to navigate effectively across cultures; use twenty-first century skills to understand and address global issues; learn from, and work collaboratively with individuals from diverse cultures, religions, and lifestyles in a spirit of mutual respect and open dialogue; and/or leverage social and cultural differences to create new ideas and achieve success.

Non-limiting examples of micro-credits/badges for adaptability, initiative, and risk-taking competencies can include, but are not limited to: develop flexibility, agility, and adaptability; bring a sense of courage to unfamiliar situations; explore and experiment; work effectively in a climate of ambiguity and changing priorities; view failure as an opportunity to learn, and acknowledge that innovation involves small successes and frequent mistakes; cultivate an independence of spirit to explore new roles, ideas, and strategies; develop entrepreneurial literacy; and/or use creativity and innovation to produce things that are unique and that have value and meaning.

Non-limiting examples of various micro-credits/badges for habits of mind competencies can include, but are not limited to: conscientiousness; creativity; love of learning/curiosity; resilience; persistence; self-efficacy; and/or stress management.

Integrity and ethical decision-making competencies can include various micro-credits/badges such as, but not limited to: sustain an empathetic and compassionate outlook; foster integrity, honesty, fairness, and respect; exhibit moral courage in confronting unjust situations; act responsibly, with the interests and well-being of the larger community in mind; develop a fundamental understanding of emerging ethical issues and dilemmas regarding new media and technologies; and/or make reasoned and ethical decisions in response to complex problems.

Examples of various micro-credits/badges for complex communication (oral and written) competencies, can include, but are not limited to: understand and express ideas in two or more languages; communicate clearly to diverse audiences; listen attentively; speak effectively; write clearly and concisely for a variety of audiences; and/or explain information and compellingly persuade others of its implications. Further to these example micro-credits/badges, examples of evidence that can be utilized include, but are not limited to: public policy debate; Lincoln-Douglas debate; persuasive speech; extemporaneous speech; discussion participant; projection, articulation and pronunciation; formal speech delivery; and/or cross examination.

According to some implementations, the mastery transcript and related outcomes can be guided by one or more principles. For example, a first principle can be that there could be no standardization of content. The performance areas, credit standards (rubrics, and so on) and credits can be specific only to the individual crediting school, and are not standardized across schools. However, according to some implementations, standardizations can be applied. A second principle can be that there are no grades (e.g., letter grading (or numerical equivalent) is not used). A third principle can be a consistent transcript format. For example, the transcript should be readable by college admission officers (once trained) in less than a few minutes. Therefore, the transcript format should be reasonably consistent. However, it is noted that other principles can be applied in accordance with one or more aspects discussed herein.

FIG. 25 illustrates a portion of an example, non-limiting, transcript 2500 in accordance with one or more embodiments described herein. Repetitive description of like elements employed in other embodiments described herein is omitted for sake of brevity.

In this example, a pie chart 2502 can be provided that ranks the students on the different capabilities (e.g., numbered 1 through 8), such as the capabilities discussed above. The pie chart 2502 can be utilized to emphasize the proficiency of the student for the one or more capabilities and compared to the other capabilities. Detailed information about each capability can be provided (not shown). For example, the detailed information can include one or more narratives related to the capabilities demonstrated by the student.

Further, the transcript 2500 can include featured credits 2504. This section can be utilized to illustrate areas that the student would like to emphasize and/or areas in which the student demonstrated excellent proficiencies.

The transcript 2500, therefor can be visually appealing. Further, the transcript 2500 can provide a quick view that provides more information related to the student as compared to traditional letter grades associated with particular classes.

FIG. 26 illustrates an example, non-limiting, technology platform flow 2600 that can be utilized in accordance with one or more embodiments described herein. The technology platform flow 2600 can comprise one or more of the components and/or functionalities of the system 100, the system 200, the system 300, the system 400, the system 500, the system 600, the system 700, the system 800, the system 900, the system 1000, the system 1100, the system 1200, and vice versa. Repetitive description of like elements employed in other embodiments described herein is omitted for sake of brevity.

At 2602, evidence (e.g., the input data 110) can be submitted (e.g., via the interface component 208). For example, the evidence can be submitted by a student (e.g., target entity/submitting entity), a teacher (e.g., submitting entity), and/or another submitting entity. The evidence can relate to various work performed by the student including, for example, a chemistry research project, a portrait sketched by the student, a chart and related information researched by the student, a sound (or video) recording of a speech given by the student, and so on). The evidence can be investigated and/or determined through various means including, for example, a mobile computing device, a printer, a scanner, a laptop computer, and/or one or more APIs. In computer programming, an API is a set of subroutine definitions, protocols, and tools for building application software. In general terms, an API is a set of clearly defined methods of communication between various software components.

As illustrated, the evidence can be retained in the cloud 2604 or another type of storage (e.g., the database 206). The evidence can be managed or curated, at 2606 (e.g., via the interface component 208) by the student, an advisor, a counselor, or another individual assisting the student (e.g., a parent, a trusted friend, and so on). For example, the input data can be sorted, prioritized, feedback can be provided (e.g., to the student), the input data can be organized (e.g., badges can be placed in appropriate folders), and so on. The curation of the data can be performed automatically, as discussed herein, due to the vast amount of data that can be generated and gathered over time.

As desired, refinement of the data can be facilitated, as indicated by line 2608 (e.g., via the interface component 208). Upon or after the refinement of the data has been completed, the information (e.g., mastery transcript and related evidence) can be submitted for review, at 2610. For example, the information can be submitted to one or more colleges for review and potential acceptance into the college(s).

Portfolio review can be performed, at 2612. For example, the information can be output at respective devices of one or more requesting entities (e.g., a teacher, an admissions panel, and so on). According to some implementations, during the review, the one or more badge folders can be compared with respective rubrics. In some cases, feedback on the portfolio can be provided and one or more modifications can be made. In other cases, or upon or after the feedback has been addressed, the portfolio can be approved.

One or more evidence from the portfolio can be added to the transcript, at 2614. The transcript can be created, at 2616. For example, creation of the transcript can be in various stages, such as in process, graduation, and/or locked. According to some implementations, the transcript can be printed, downloaded, and/or submitted to one or more colleges (e.g., via an API).

According to an implementation, an API can be provided that can facilitate various access to the transcript. For example, the API can facilitate review and/or evaluation of the portfolio, rubric, and/or work. In addition, the API can facilitate access to school standards, can facilitate an output that comprises a comparison between schools, and can facilitate other information associated with one or more schools and data related to the schools.

Upon or after receipt at the one or more colleges, the mastery transcript can be reviewed, at 2618 (e.g., via the output component 310). For example, the review can be performed based on the one or more badges, the one or more rubric, and/or the various supporting work and other supporting data. Thereafter, the student can be accepted 2620 into the college based, in part, on the mastery transcript provided. The transcript can be utilized as a base, or a part of, a lifetime transcript as discussed herein.

According to an implementation, provided is a system that can comprise a memory that stores computer executable components and a processor that executes the computer executable components stored in the memory. The computer executable components can comprise a data manager component that receives first data and second data from a source entity. The first data can comprise a first set of content and the second data can comprise a second set of content. The first set of content and the second set of content can contribute to a holistic life view of a target entity. The computer executable components can also comprise an analysis component that adds a first metadata to the first data based on the first set of content, and adds a second metadata to the second data based on the second set of content. The first metadata and the second metadata can facilitate ease of retrieval of the first data and the second data from a reference database. Further, the first metadata and the second metadata can indicate the first set of content and the second set of content are related to the target entity. Further, the computer executable components can comprise an output component that renders aggregated content at varying viewing granularity levels based on a first request for the holistic life view of the target entity. The aggregated content can comprise the first set of content, the second set of content, and historical information determined to be associated with the target entity.

In an example, the varying viewing granularity levels can comprise a first granularity level, a second granularity level that is greater than the first granularity level, and a third granularity level that is greater than the second granularity level. The output component can initially render the aggregated content at the first granularity level.

According another example, the computer executable components can further comprise a zooming component that can change the varying viewing granularity levels from the first granularity level to the second granularity level based on a second request for additional details related to a subset of the aggregated content. In accordance with an example, the zooming component can change from the second granularity level to the third granularity level based on a third request for in-depth review of a defined portion of the subset of the aggregated content.

The computer executable components can also comprise, for example, an index component that can apply respective indications to the first data and the second data. Further to this example, the output component can render the aggregated content based on an order specified by the respective indications.

According to another example, the computer executable components can further comprise a correlation component that can cross-reference the first set of content with the historical information related to the target entity based on a determination that the historical information comprises the first metadata.

In accordance with another example, the computer executable components can further comprise a security component that can restrict access to the aggregated content based on rendering criteria. The rendering criteria can be based on at least one of: credentials of a requesting entity, information in the aggregated content, a completion level of the aggregated content, preferences of the target entity, or combinations thereof.

The computer executable components can further comprise, for example, a virtual reality component that can output a first portion of the aggregated content in a virtual environment experience format. The virtual environment experience format can comprise an initialized view at a high-level that is selectively altered based on a second request for detailed artifacts related to a second portion of the aggregated content.

In another example, the computer executable components can further comprise an equalization component that can normalize one or more portions of the aggregated content as compared to other aggregated content associated with another target entity.

According to another example, the computer executable components can further comprise an observation component that can evaluate the first data for a trigger event. Further, the computer executable components can comprise an interface component that can provide a notification to the target entity based on an occurrence of the trigger event.

As an example, the first data can comprise a first data type and the second data can comprise a second data type different from the first data.

Another embodiment provide herein can relate to a method that can comprise receiving, by a system operatively coupled to a processor, a first set of content related to a first target entity and a second set of content related to a second target entity. The method can also comprise augmenting, by the system, the first set of content with a first metadata and the second set of content with a second metadata. The first metadata can associate the first set of content with the first target entity and the second metadata can associate the second set of content with the second target entity. Further, the method can comprise storing, by the system, the first set of content, the first metadata, the second set of content, and the second metadata in a reference database that can comprise a first set of historical content associated with the first target entity and a second set of historical content associated with the second target entity. In addition, the method can comprise outputting, by the system, at varying viewing granularity levels, at least one of a first set of aggregated content and a second set of aggregated content. The first set of aggregated content can be based on a first request for a first holistic life view of the first target entity. The first set of aggregated content can comprise the first set of content, the first metadata, and the first set of historical content. The second set of aggregated content can be based on a second request for a second holistic life view of the second target entity. The second set of aggregated content can comprise the second set of content, the second metadata, and the second set of historical content.

For example, the varying viewing granularity levels can comprise a first granularity level, a second granularity level that is greater than the first granularity level, and a third granularity level that is greater than the second granularity level. Further to this example, the method can comprise outputting the first set of aggregated content or the second set of aggregated content at the first granularity level.

In another example, the method can comprise altering, by the system, the varying viewing granularity levels from the first granularity level to the second granularity level based on a third request for additional details related to a first subset of the first set of aggregated content or a second subset of the second set of aggregated content. Further to this example, the method can comprise adjusting, by the system, the varying viewing granularity levels from the second granularity level to the third granularity level based on a fourth request for a first in-depth review of a first defined portion of the first set of aggregated content or a second in-depth review of a second defined portion of the second set of aggregated content.

According to some examples, the method can comprise restricting, by the system, access to the first set of aggregated content based on a first defined rendering criterion. Further to these examples, the method can also comprise restricting, by the system, access to the second set of aggregated content based on a second defined rendering criterion.

A further embodiment can relate to a computer readable storage device that can comprise executable instructions that, in response to execution, cause a system comprising a processor to perform operations. The operations can comprise receiving first data and second data from a source entity. The first data can comprise a first set of content and the second data can comprise a second set of content. The first set of content and the second set of content can contribute to a holistic life view of a target entity. The operations can also comprise adding a first metadata to the first data based on the first set of content and a second metadata to the second data based on the second set of content. The first metadata and the second metadata can facilitate ease of retrieval of the first data and the second data from a reference database. The first metadata and the second metadata can indicate the first set of content and the second set of content are related to the target entity. Further, the operations can comprise outputting aggregated content at varying viewing granularity levels based on a first request for the holistic life view of the target entity. The aggregated content can comprise the first set of content, the second set of content, and historical information determined to be associated with the target entity.

According to an example, the operations can comprise applying respective indications to the first data and the second data. Outputting the aggregated content can comprise outputting the aggregated content based on an order specified by the respective indications.

In accordance with another example, the operations can comprise rendering a first portion of the aggregated content in a virtual environment experience format. The virtual environment experience format can comprise an initialized view at a high-level that is selectively altered based on a second request for detailed artifacts related to a second portion of the aggregated content.

In another example, the operations can comprise evaluating the first data for a trigger event. Further to this example, the operations can comprise providing a notification to the target entity based on an occurrence of the trigger event.

For simplicity of explanation, the computer-implemented methodologies are depicted and described as a series of acts. It is to be understood and appreciated that the subject innovation is not limited by the acts illustrated and/or by the order of acts, for example acts can occur in various orders and/or concurrently, and with other acts not presented and described herein. Furthermore, not all illustrated acts can be required to implement the computer-implemented methodologies in accordance with the disclosed subject matter. In addition, those skilled in the art will understand and appreciate that the computer-implemented methodologies could alternatively be represented as a series of interrelated states via a state diagram or events. Additionally, it should be further appreciated that the computer-implemented methodologies disclosed hereinafter and throughout this specification are capable of being stored on an article of manufacture to facilitate transporting and transferring such computer-implemented methodologies to computers. The term article of manufacture, as used herein, is intended to encompass a computer program accessible from any computer-readable device or storage media.

To provide further context for various aspects of the disclosed subject matter, FIG. 27 illustrates a block diagram of an embodiment of access equipment and/or software 2700 related to access of a network (e.g., base station, wireless access point, femto cell access point, and so forth) that can enable and/or exploit features or aspects of the disclosed aspects.

Access equipment and/or software 2700 related to access of a network can receive and transmit signal(s) from and to wireless devices, wireless ports, wireless routers, etc. through segments 2702₁-1102_{B} (B is a positive integer). Segments 2702₁-402_{B} can be internal and/or external to access equipment and/or software 2700 related to access of a network, and can be controlled by a monitor component 2704 and an antenna component 2706. Monitor component 2704 and antenna component 2706 can couple to communication platform 2708, which can include electronic components and associated circuitry that provide for processing and manipulation of received signal(s) and other signal(s) to be transmitted.

In an aspect, communication platform 2708 includes a receiver/transmitter 2710 that can convert analog signals to digital signals upon reception of the analog signals, and can convert digital signals to analog signals upon transmission. In addition, receiver/transmitter 2710 can divide a single data stream into multiple, parallel data streams, or perform the reciprocal operation. Coupled to receiver/transmitter 2710 can be a multiplexer/demultiplexer 2712 that can facilitate manipulation of signals in time and frequency space. Multiplexer/demultiplexer 2712 can multiplex information (data/traffic and control/signaling) according to various multiplexing schemes such as time division multiplexing, frequency division multiplexing, orthogonal frequency division multiplexing, code division multiplexing, space division multiplexing. In addition, multiplexer/demultiplexer component 2712 can scramble and spread information (e.g., codes, according to substantially any code known in the art, such as Hadamard-Walsh codes, Baker codes, Kasami codes, polyphase codes, and so forth).

A modulator/demodulator 2714 is also a part of communication platform 2708, and can modulate information according to multiple modulation techniques, such as frequency modulation, amplitude modulation (e.g., M-ary quadrature amplitude modulation, with M a positive integer); phase-shift keying; and so forth).

Access equipment and/or software 2700 related to access of a network also includes a processor 2716 configured to confer, at least in part, functionality to substantially any electronic component in access equipment and/or software 2700. In particular, processor 2716 can facilitate configuration of access equipment and/or software 2700 through, for example, monitor component 2704, antenna component 2706, and one or more components therein. Additionally, access equipment and/or software 2700 can include display interface 2718, which can display functions that control functionality of access equipment and/or software 2700, or reveal operation conditions thereof. In addition, display interface 2718 can include a screen to convey information to an end user. In an aspect, display interface 2718 can be a liquid crystal display, a plasma panel, a monolithic thin-film based electrochromic display, and so on. Moreover, display interface 2718 can include a component (e.g., speaker) that facilitates communication of aural indicia, which can also be employed in connection with messages that convey operational instructions to an end user. Display interface 2718 can also facilitate data entry (e.g., through a linked keypad or through touch gestures), which can cause access equipment and/or software 2700 to receive external commands (e.g., restart operation).

Broadband network interface 2720 facilitates connection of access equipment and/or software 2700 to a service provider network (not shown) that can include one or more cellular technologies (e.g., third generation partnership project universal mobile telecommunication system, global system for mobile communication, and so on) through backhaul link(s) (not shown), which enable incoming and outgoing data flow. Broadband network interface 2720 can be internal or external to access equipment and/or software 2700, and can utilize display interface 2718 for end-user interaction and status information delivery.

Processor 2716 can be functionally connected to communication platform 2708 and can facilitate operations on data (e.g., symbols, bits, or chips) for multiplexing/demultiplexing, such as effecting direct and inverse fast Fourier transforms, selection of modulation rates, selection of data packet formats, inter-packet times, and so on. Moreover, processor 2716 can be functionally connected, through data, system, or an address bus 2722, to display interface 2718 and broadband network interface 2720, to confer, at least in part, functionality to each of such components.

In access equipment and/or software 2700, memory 2724 can retain location and/or coverage area (e.g., macro sector, identifier(s)) access list(s) that authorize access to wireless coverage through access equipment and/or software 2700, sector intelligence that can include ranking of coverage areas in the wireless environment of access equipment and/or software 2700, radio link quality and strength associated therewith, or the like. Memory 2724 also can store data structures, code instructions and program modules, system or device information, code sequences for scrambling, spreading and pilot transmission, access point configuration, and so on. Processor 2716 can be coupled (e.g., through a memory bus), to memory 2724 in order to store and retrieve information used to operate and/or confer functionality to the components, platform, and interface that reside within access equipment and/or software 2700.

As it is employed in the subject specification, the term “processor” can refer to substantially any computing processing unit or device including, but not limited to including, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions and/or processes described herein. Processors can exploit nano-scale architectures such as, but not limited to, molecular and quantum-dot based transistors, switches and gates, in order to optimize space usage or enhance performance of mobile devices. A processor can also be implemented as a combination of computing processing units.

In the subject specification, terms such as “store,” “data store,” “data storage,” “database,” and substantially any other information storage component relevant to operation and functionality of a component and/or process, refer to “memory components,” or entities embodied in a “memory,” or components including the memory. It is noted that the memory components described herein can be either volatile memory or nonvolatile memory, or can include both volatile and nonvolatile memory.

By way of illustration, and not limitation, nonvolatile memory, for example, can be included in memory 2724, non-volatile memory (see below), disk storage (see below), and memory storage (see below). Further, nonvolatile memory can be included in read only memory, programmable read only memory, electrically programmable read only memory, electrically erasable programmable read only memory, or flash memory. Volatile memory can include random access memory, which acts as external cache memory. By way of illustration and not limitation, random access memory is available in many forms such as synchronous random access memory, dynamic random access memory, synchronous dynamic random access memory, double data rate synchronous dynamic random access memory, enhanced synchronous dynamic random access memory, Synchlink dynamic random access memory, and direct Rambus random access memory. Additionally, the disclosed memory components of systems or methods herein are intended to include, without being limited to including, these and any other suitable types of memory.

In order to provide a context for the various aspects of the disclosed subject matter, FIG. 28, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the various aspects also can be implemented in combination with other program modules. Generally, program modules include routines, programs, components, data structures, etc. that perform particular tasks and/or implement particular abstract data types. For example, in memory (such as the memory 106) there can be software, which can instruct a processor (such as the processing component 104) to perform various actions. The processor can be configured to execute the instructions in order to implement the analysis of monitoring an uplink power level, detecting the uplink power level is at or above a threshold level, and/or disable transmission of at least one message as a result of the monitored uplink power level.

Moreover, those skilled in the art will understand that the various aspects can be practiced with other computer system configurations, including single-processor or multiprocessor computer systems, mini-computing devices, mainframe computers, as well as personal computers, base stations hand-held computing devices or user equipment, such as a tablet, phone, watch, and so forth, processor-based computers/systems, microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

With reference to FIG. 28, a block diagram of a computing system 2800 operable to execute the disclosed systems and methods is illustrated, in accordance with an embodiment. Computer 2802 includes a processing unit 2804, a system memory 2806, and a system bus 2808. System bus 2808 couples system components including, but not limited to, system memory 2806 to processing unit 2804. Processing unit 2804 can be any of various available processors. Dual microprocessors and other multiprocessor architectures also can be employed as processing unit 2804.

System bus 2808 can be any of several types of bus structure(s) including a memory bus or a memory controller, a peripheral bus or an external bus, and/or a local bus using any variety of available bus architectures including, but not limited to, industrial standard architecture, micro-channel architecture, extended industrial standard architecture, intelligent drive electronics, video electronics standards association local bus, peripheral component interconnect, card bus, universal serial bus, advanced graphics port, personal computer memory card international association bus, Firewire (e.g., Institute of Electrical and Electronics Engineers 1394 interface), and small computer systems interface.

System memory 2806 includes volatile memory 2810 and nonvolatile memory 2812. A basic input/output system, containing routines to transfer information between elements within computer 2802, such as during start-up, can be stored in nonvolatile memory 2812. By way of illustration, and not limitation, nonvolatile memory 2812 can include read only memory, programmable read only memory, electrically programmable read only memory, electrically erasable programmable read only memory, or flash memory. Volatile memory 2810 can include random access memory, which acts as external cache memory. By way of illustration and not limitation, random access memory is available in many forms such as dynamic random access memory, synchronous random access memory, synchronous dynamic random access memory, double data rate synchronous dynamic random access memory, enhanced synchronous dynamic random access memory, Synchlink dynamic random access memory, and direct Rambus random access memory, direct Rambus dynamic random access memory, and Rambus dynamic random access memory.

Computer 2802 also includes removable/non-removable, volatile/non-volatile computer storage media. In an implementation, provided is a non-transitory or tangible computer-readable storage device storing executable instructions that, in response to execution, cause a system comprising a processor to perform operations.

FIG. 28 illustrates, for example, disk storage 2814. Disk storage 2814 includes, but is not limited to, devices such as a magnetic disk drive, floppy disk drive, tape drive, external or internal removable storage drives, superdisk drive, flash memory card, or memory stick. In addition, disk storage 2814 can include storage media separately or in combination with other storage media including, but not limited to, an optical disk drive such as a compact disk read only memory device, compact disk recordable drive, compact disk rewritable drive or a digital versatile disk read only memory drive. To facilitate connection of the disk storage 2814 to system bus 2808, a removable or non-removable interface is typically used, such as interface component 2816.

It is to be noted that FIG. 28 describes software that acts as an intermediary between users and computer resources described in suitable operating environment. Such software includes an operating system 2818. Operating system 2818, which can be stored on disk storage 2814, acts to control and allocate resources of computer system 2802. System applications 2820 can take advantage of the management of resources by operating system 2818 through program modules 2822 and program data 2824 stored either in system memory 2806 or on disk storage 2814. It is to be understood that the disclosed subject matter can be implemented with various operating systems or combinations of operating systems.

A user can enter commands or information, for example through interface component 2816, into computer system 2802 through input device(s) 2826. Input devices 2826 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to processing unit 2804 through system bus 2808 through interface port(s) 2828. Interface port(s) 2828 include, for example, a serial port, a parallel port, a game port, and a universal serial bus. Output device(s) 2830 uses some of the same type of ports as input device(s) 2826.

Thus, for example, a universal serial bus port can be used to provide input to computer 2802 and to output information from computer 2802 to an output device 2830. Output adapter 2832 is provided to illustrate that there are some output devices 2830, such as monitors, speakers, and printers, among other output devices 2830, which use special adapters. Output adapters 2832 include, by way of illustration and not limitation, video and sound cards that provide means of connection between output device 2830 and system bus 2808. It is also noted that other devices and/or systems of devices provide both input and output capabilities such as remote computer(s) 2834.

Computer 2802 can operate in a networked environment using logical connections to one or more remote computers, such as remote computer(s) 2834. Remote computer(s) 2834 can be a personal computer, a server, a router, a network computer, a workstation, a microprocessor based appliance, a peer device, or other common network node and the like, and typically includes many or all of the elements described relative to computer 2802.

For purposes of brevity, only one memory storage device 2836 is illustrated with remote computer(s) 2834. Remote computer(s) 2834 is logically connected to computer 2802 through a network interface 2838 and then physically connected through communication connection 2840. Network interface 2838 encompasses wire and/or wireless communication networks such as local area networks and wide area networks. Local area network technologies include fiber distributed data interface, copper distributed data interface, Ethernet, token ring and the like. Wide area network technologies include, but are not limited to, point-to-point links, circuit switching networks, such as integrated services, digital networks, and variations thereon, packet switching networks, and digital subscriber lines.

Communication connection(s) 2840 refer(s) to hardware/software employed to connect network interface 2838 to system bus 2808. While communication connection 2840 is shown for illustrative clarity inside computer 2802, it can also be external to computer 2802. The hardware/software for connection to network interface 2838 can include, for example, internal and external technologies such as modems, including regular telephone grade modems, cable modems and Digital Subscriber Line (DSL) modems, Integrated Services Digital Network (ISDN) adapters, and Ethernet cards.

It is to be noted that aspects described in the subject specification can be exploited in substantially any communication technology. For example, 4G technologies, Wi-Fi, worldwide interoperability for microwave access, enhanced gateway general packet radio service, third generation partnership project long term evolution, third generation partnership project 3 ultra mobile broadband, third generation partnership project universal mobile telecommunication system, high speed packet access, high-speed downlink packet access, high-speed uplink packet access, global system for mobile communication edge radio access network, universal mobile telecommunication system terrestrial radio access network, long term evolution advanced. Additionally, substantially all aspects disclosed herein can be exploited in legacy telecommunication technologies; e.g., global system for mobile communication. In addition, mobile as well non-mobile networks (e.g., Internet, data service network such as Internet protocol television) can exploit aspect or features described herein.

FIG. 29 is a schematic block diagram of a sample computing environment 2900 with which the disclosed subject matter can interact. The sample computing environment 2900 includes one or more client(s) 2902. The client(s) 2902 can be hardware and/or software (e.g., threads, processes, computing devices). The sample computing environment 2900 also includes one or more server(s) 2904. The server(s) 2904 can also be hardware and/or software (e.g., threads, processes, computing devices). The servers 2904 can house threads to perform transformations by employing one or more embodiments as described herein, for example. One possible communication between a client 2902 and servers 2904 can be in the form of a data packet adapted to be transmitted between two or more computer processes. The sample computing environment 2900 includes a communication framework 2906 that can be employed to facilitate communications between the client(s) 2902 and the server(s) 2904. The client(s) 2902 are operably connected to one or more client data store(s) 2908 that can be employed to store information local to the client(s) 2902. Similarly, the server(s) 2904 are operably connected to one or more server data store(s) 2910 that can be employed to store information local to the servers 2904.

Reference throughout this specification to “one embodiment,” or “an embodiment,” means that a particular feature, structure, or characteristic described in connection with the embodiment is included in at least one embodiment. Thus, the appearances of the phrase “in one embodiment,” “in one aspect,” or “in an embodiment,” in various places throughout this specification are not necessarily all referring to the same embodiment. Furthermore, the particular features, structures, or characteristics can be combined in any suitable manner in one or more embodiments.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

As used in this disclosure, in some embodiments, the terms “component,” “system,” “interface,” “manager,” and the like are intended to refer to, or comprise, a computer-related entity or an entity related to an operational apparatus with one or more specific functionalities, wherein the entity can be either hardware, a combination of hardware and software, software, or software in execution, and/or firmware. As an example, a component can be, but is not limited to being, a process running on a processor, a processor, an object, an executable, a thread of execution, computer-executable instructions, a program, and/or a computer. By way of illustration and not limitation, both an application running on a server and the server can be a component

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software application or firmware application executed by one or more processors, wherein the processor can be internal or external to the apparatus and can execute at least a part of the software or firmware application. As yet another example, a component can be an apparatus that provides specific functionality through electronic components without mechanical parts, the electronic components can comprise a processor therein to execute software or firmware that confer(s) at least in part the functionality of the electronic components. In an aspect, a component can emulate an electronic component via a virtual machine, e.g., within a cloud computing system. While various components have been illustrated as separate components, it will be appreciated that multiple components can be implemented as a single component, or a single component can be implemented as multiple components, without departing from example embodiments

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

In addition, the various embodiments can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, machine-readable device, computer-readable carrier, computer-readable media, machine-readable media, computer-readable (or machine-readable) storage/communication media. For example, computer-readable media can comprise, but are not limited to, a magnetic storage device, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a storage device and/or any of the above computer-readable media. Of course, those skilled in the art will recognize many modifications can be made to this configuration without departing from the scope or spirit of the various embodiments

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the subject matter has been described herein in connection with various embodiments and corresponding FIGs, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A system, comprising:
a memory that stores computer executable components; and
a processor that executes the computer executable components stored in the memory, wherein the computer executable components comprise:
a data manager component that receives first data and second data from a source entity, wherein the first data comprises a first set of content and the second data comprises a second set of content, and wherein the first set of content and the second set of content contribute to a holistic life view of a target entity;
an analysis component that adds a first metadata to the first data based on the first set of content, and adds a second metadata to the second data based on the second set of content, wherein the first metadata and the second metadata facilitate ease of retrieval of the first data and the second data from a reference database, and wherein the first metadata and the second metadata indicate the first set of content and the second set of content are related to the target entity; and
an output component that renders aggregated content at varying viewing granularity levels based on a first request for the holistic life view of the target entity, wherein the aggregated content comprises the first set of content, the second set of content, and historical information determined to be associated with the target entity.

2. The system of claim 1, wherein the varying viewing granularity levels comprise a first granularity level, a second granularity level that is greater than the first granularity level, and a third granularity level that is greater than the second granularity level, and wherein the output component initially renders the aggregated content at the first granularity level.

3. The system of claim 2, wherein the computer executable components further comprise:
a zooming component that changes the varying viewing granularity levels from the first granularity level to the second granularity level based on a second request for additional details related to a subset of the aggregated content.

4. The system of claim 3, wherein the zooming component changes from the second granularity level to the third granularity level based on a third request for in-depth review of a defined portion of the subset of the aggregated content.

5. The system of claim 1, wherein the computer executable components further comprise:
an index component that applies respective indications to the first data and the second data, wherein the output component renders the aggregated content based on an order specified by the respective indications.

6. The system of claim 1, wherein the computer executable components further comprise:
a correlation component that cross-references the first set of content with the historical information related to the target entity based on a determination that the historical information comprises the first metadata.

7. The system of claim 1, wherein the computer executable components further comprise:
a security component that restricts access to the aggregated content based on rendering criteria, wherein the rendering criteria is based on at least one of: credentials of a requesting entity, information in the aggregated content, a completion level of the aggregated content, preferences of the target entity, or combinations thereof.

8. The system of claim 1, wherein the computer executable components further comprise:
a virtual reality component that outputs a first portion of the aggregated content in a virtual environment experience format, wherein the virtual environment experience format comprises an initialized view at a high-level that is selectively altered based on a second request for detailed artifacts related to a second portion of the aggregated content.

9. The system of claim 1, wherein the computer executable components further comprise:
an equalization component that normalizes one or more portions of the aggregated content as compared to other aggregated content associated with another target entity.

10. The system of claim 1, wherein the computer executable components further comprise:
an observation component that evaluates the first data for a trigger event; and
an interface component that provides a notification to the target entity based on an occurrence of the trigger event.

11. The system of claim 1, wherein the first data comprises a first data type and the second data comprises a second data type different from the first data type.

12. A method, comprising:
receiving, by a system operatively coupled to a processor, a first set of content related to a first target entity and a second set of content related to a second target entity;
augmenting, by the system, the first set of content with a first metadata and the second set of content with a second metadata, wherein the first metadata associates the first set of content with the first target entity and the second metadata associates the second set of content with the second target entity;
storing, by the system, the first set of content, the first metadata, the second set of content, and the second metadata in a reference database that comprises a first set of historical content associated with the first target entity and a second set of historical content associated with the second target entity; and
outputting, by the system, at varying viewing granularity levels, at least one of:
a first set of aggregated content based on a first request for a first holistic life view of the first target entity, wherein the first set of aggregated content comprises the first set of content, the first metadata, and the first set of historical content; and
a second set of aggregated content based on a second request for a second holistic life view of the second target entity, wherein the second set of aggregated content comprises the second set of content, the second metadata, and the second set of historical content.

13. The method of claim 12, wherein the varying viewing granularity levels comprise a first granularity level, a second granularity level that is greater than the first granularity level, and a third granularity level that is greater than the second granularity level, and wherein the method further comprises outputting the first set of aggregated content or the second set of aggregated content at the first granularity level.

14. The method of claim 13, further comprising:
altering, by the system, the varying viewing granularity levels from the first granularity level to the second granularity level based on a third request for additional details related to a first subset of the first set of aggregated content or a second subset of the second set of aggregated content.

15. The method of claim 14, further comprising;
adjusting, by the system, the varying viewing granularity levels from the second granularity level to the third granularity level based on a fourth request for a first in-depth review of a first defined portion of the first set of aggregated content or a second in-depth review of a second defined portion of the second set of aggregated content.

16. The method of claim 12, further comprising:
restricting, by the system, access to the first set of aggregated content based on a first defined rendering criterion; and
restricting, by the system, access to the second set of aggregated content based on a second defined rendering criterion.

17. A computer readable storage device comprising executable instructions that, in response to execution, cause a system comprising a processor to perform operations, comprising:
receiving first data and second data from a source entity, wherein the first data comprises a first set of content and the second data comprises a second set of content, and wherein the first set of content and the second set of content contribute to a holistic life view of a target entity;
adding a first metadata to the first data based on the first set of content and a second metadata to the second data based on the second set of content, wherein the first metadata and the second metadata facilitate ease of retrieval of the first data and the second data from a reference database, and wherein the first metadata and the second metadata indicate the first set of content and the second set of content are related to the target entity; and
outputting aggregated content at varying viewing granularity levels based on a first request for the holistic life view of the target entity, wherein the aggregated content comprises the first set of content, the second set of content, and historical information determined to be associated with the target entity.

18. The computer readable storage device of claim 17, wherein the operations further comprise:
applying respective indications to the first data and the second data, wherein the outputting the aggregated content comprises outputting the aggregated content based on an order specified by the respective indications.

19. The computer readable storage device of claim 17, wherein the operations further comprise:
rendering a first portion of the aggregated content in a virtual environment experience format, wherein the virtual environment experience format comprises an initialized view at a high-level that is selectively altered based on a second request for detailed artifacts related to a second portion of the aggregated content.

20. The computer readable storage device of claim 17, wherein the operations further comprise:
evaluating the first data for a trigger event; and
providing a notification to the target entity based on an occurrence of the trigger event.
